(19) United States
(12) Patent Application Publication
(10) Pub. No.: US 2023/0222822 A1
(43) Pub. Date: Jul. 13, 2023

(54) SYSTEMS AND METHODS FOR ASSESSMENT OF FOOD ITEM DRYNESS

(71) Applicant: Apeel Technology, Inc., Goleta, CA (US)

(72) Inventors: Amy Melina Jefferson, Goleta, CA (US); Sahana Venkatesh, Goleta, CA (US); Pooyan Abouzar, Goleta, CA (US); Richard Pattison, Goleta, CA (US); Ohad Michel, Goleta, CA (US); Julius Tschannerl, Goleta, CA (US)

(21) Appl. No.: 18/090,969

(22) Filed: Dec. 29, 2022

Related U.S. Application Data
(60) Provisional application No. 63/295,169, filed on Dec. 30, 2021.

(51) Int. Cl. G06V 20/68; G01J 5/00

(52) U.S. Cl. CPC G06V 20/68; G01J 5/00; G01J 2005/0077

(57) ABSTRACT

Described herein are systems and methods for determining dryness of produce using image data. A method can include receiving, by a computing system and from an imaging device, image data of a batch of produce, performing, by the computing system, object detection to identify each produce in a frame of the image data, extracting, by the computing system, temperature values in pixels of the identified produce in the frame, and determining, by the computing system, distribution characteristics of the extracted temperature values. The method can also include predicting, by the computing system, a dryness metric for the batch of produce based on applying a trained model to the determined distribution characteristics. The model can be trained using temperature distributions of other produce, the temperature distributions being annotated based on previous mappings of skewness of the temperature distributions to dryness.

### INCORPORATION BY REFERENCE

This application claims priority to U.S. Provisional Application Ser. No. 63/295,169, filed on Dec. 30, 2021, the disclosure of which is incorporated by reference in its entirety.

### TECHNICAL FIELD

This document describes devices, systems, and methods related to determining quality of food items based on, for example, image data of the food items.

### BACKGROUND

Food items, such as produce (e.g., fruits and vegetables) can have different levels of surface moisture that can impact a supply chain. Some levels of leftover surface moisture on the produce may cause downstream problems, such as stickering the produce before delivering the produce to consumers. Some levels of leftover surface moisture on the produce may also cause dust to settle in equipment used throughout the supply chain, where the equipment may get wet from produce having leftover surface moisture. This can cause damage or malfunctioning of the equipment. Dryness of the produce may also affect integrity of coatings applied to the produce in the supply chain. With early identification of the dryness of produce, supply chain modifications can be made to avoid causing downstream issues in the supply chain.

Objectively and quantitatively identifying dryness of produce based on thermal image data can be challenging. Different locations, such as warehouses, where produce is kept before transit can have different ambient conditions. These ambient conditions can impact not only ability of surface moisture of the produce to dry but also accuracy of temperature readings in thermal image data.

### SUMMARY

The document generally describes systems, methods, and techniques for non-invasively assessing the dryness of food items, herein described as produce (e.g., vegetables, fruits), based on, for example, image data. The image data can be generated and captured by one or more imaging devices, such as thermal imaging cameras that are configured to capture images of the produce in which pixels of the image data represent temperature values. Using this image data, the disclosed technology can provide for determining a dryness metric for the produce by using temperature values of the produce as inferred from image data, determining temperature distribution characteristics, such as a skew of the temperature values, and correlating those characteristics to the dryness metric. Any of a variety of techniques can be used to determine dryness metrics, such as using trained machine learning models to perform the disclosed techniques.

Using the disclosed technology, the dryness metric can be used to determine any of a variety of details about the produce and/or the systems/devices processing the produce, such as a quality of a shelf life extension coating solution, settings for processing the produce (e.g., dryer settings, shelf life extending solutions applied to the produce), and one or more supply chain modifications. For example, before produce is put in transit to retail environments and end consumers, the produce can be coated in the shelf life extension coating solution. A formula for the solution can continuously change based on a variety of factors, including but not limited to environmental conditions (e.g., ambient temperature, humidity, barometric pressure), produce origin, and characteristics of the produce. The formula may, for example, change based on a dryness of the produce before the produce is shipped to the retail environments so that the shelf life extension coating solution can be more consistent. Therefore, the disclosed technology can be used to quantify the dryness of the produce and determine an improved formula for the shelf life extension coating solution and application thereof to the produce to ensure the shelf life extension coating solution remains on the produce during transit and other downstream processing in the supply chain. In some implementations, the dryness metric can also be used to determine information about quality of the produce, such as external quality issues (e.g., burn).

In some implementations, produce can be coated in the shelf life extension coating solution, put through a dryer, such as a heat tunnel, and then imaged by thermal imaging devices before being routed to a location in the warehouse for shipment to the retail environments. The disclosed technology can provide for quantifying the dryness of the produce based on image data from the thermal imaging devices. The determined dryness can be used to make adjustments to the formula for the shelf life extension coating solution that is applied to a particular type of the produce. The determined dryness can also be used to make adjustments to other preparation techniques and/or processing parameters that may be used before the particular type of produce is shipped to the retail environments, such as dryer settings. For example, if the produce comes out of the dryer more wet than dry, parameters can be adjusted to increase a temperature of the dryer and/or increase a residence time that the produce is inside the dryer. Using the disclosed techniques, dryness can be uniquely quantified for different types of produce such that different actions can be taken to improve processing of the produce throughout the supply chain.

Absolute temperature and dryness may not be well correlated because of differences in upstream configurations and/or parameters in the supply chain. Dryer parameters and other ambient environmental conditions in the supply chain can make absolute temperature of the produce a poor indicator for dryness. Instead of absolute temperature values, characteristics of surface temperature distribution, such as skewness, can be used to accurately determine dryness of the produce. The distribution of produce surface temperatures may also be characterized using one or more other methods and/or metrics. Here, the skewness of the temperature values can be correlated to dryness to determine a dryness metric for the produce (e.g., one produce, more than one produce, a batch of produce, etc.). For example, a more negative skew can indicate that the produce is dryer than a more positive skew. As a result of the disclosed technology, dryness can be more accurately determined for the produce and used to make appropriate modifications to process parameters (e.g., formula) for the shelf life extension coating solution and other produce preparation processes that may occur for the particular type of produce before the produce is shipped to retail environments and other end consumers. The disclosed technology can provide for improving or otherwise maintaining quality of the produce as it is transported to retail environment and other end consumers.

One or more embodiments described herein can include a method for determining dryness of produce using image data, the method including: receiving, by a computing system and from an imaging device, image data of a batch of produce, performing, by the computing system, object detection to identify each produce in a frame of the image data, extracting, by the computing system, temperature values in pixels of the identified produce in the frame, determining, by the computing system, distribution characteristics of the extracted temperature values, predicting, by the computing system, a dryness metric for the batch of produce based on applying a trained model to the determined distribution characteristics, and returning, by the computing system, the dryness metric for the batch of produce. The model can be trained using temperature distributions of other produce, the temperature distributions being annotated based on previous mappings of skewness of the temperature distributions to dryness.

In some implementations, the embodiments described herein can optionally include one or more of the following features. For example, the model can be at least one of a linear regression model and a non-linear regression model. The distribution characteristics can include skewness of the extracted temperature values. Determining, by the computing system, distribution characteristics of the extracted temperature values can include mapping the extracted temperature values into a histogram and analyzing a distribution of points in the histogram. Moreover, analyzing, by the computing system, the distribution of points in the histogram can include determining a skew of the points in the histogram.

In some implementations, the method can also include extracting, by the computing system, temperature values in pixels of the identified produce in the frame until a quantity of the extracted temperature values satisfies a threshold quantity. The method can also include extracting, by the computing system, temperature values in pixels of the identified produce in the frame until a quantity of produce in the frame satisfies a threshold produce quantity. The method can include extracting, by the computing system, temperature values in pixels of the identified produce in the frame until a time period of extracting the temperature values satisfies a threshold timeframe. In some implementations, the other produce can be of a different produce type than the batch of produce in the image data.

A more positive skewness metric can be correlated to a higher dryness metric, and a more negative skewness metric can be correlated to a lower dryness metric. The more negative skewness metric can indicate that the batch of produce is drier, and the more positive skewness metric can indicate that the batch of produce is wetter.

As another example, the method can include determining, by the computing system, at least one modification to a produce preparation process used for one or more batches of produce based on the dryness metric. The one or more batches of produce can be of a different produce type than the batch of produce in the image data. The produce preparation process can include coating the one or more batches of produce in a shelf life extension coating solution. The produce preparation process can also include putting the one or more batches of produce inside a drying tunnel for a predetermined amount of time to dry the one or more batches of produce. The produce preparation process can include putting the one or more batches of produce inside a heating tunnel for a predetermined amount of time at a predetermined temperature to dry the one or more batches of produce. The at least one modification to the produce preparation process can include modifying, by a produce preparation system, a formula of a shelf life extension coating solution that is applied to the one or more batches of produce before the one or more batches of produce are transported to end consumers. The at least one modification to the produce preparation process can include adjusting, by a produce preparation system, a temperature of a heating tunnel that is used to dry the one or more batches of produce before the one or more batches of produce are transported to end consumers. The at least one modification to the produce preparation process can also include adjusting, by a produce preparation system, an amount of time that the one or more batches of produce are dried in a drying tunnel before the one or more batches of produce are transported to end consumers. Sometimes, the method can also include transmitting, by the computing system and to a user device, the dryness metric of the batch of produce for display at the user device.

As another example, a higher dryness metric can be correlated with a more positive skewness metric, and a lower dryness metric can be correlated with a more negative skewness metric. The produce preparation process can include moving, by an automated conveyor system, the one or more batches of produce through a drying tunnel for a predetermined amount of time to dry the one or more batches of produce. The produce preparation process can include moving, by an automated conveyor system, the one or more batches of produce through a heating tunnel for a predetermined amount of time at a predetermined temperature to dry the one or more batches of produce.

In some implementations, determining, by the computing system, at least one modification to a produce preparation process can include: receiving a skewness metric for the batch of produce, the skewness metric being determined based on the distribution characteristics of the extracted temperature values for the batch of produce, determining whether the skewness metric satisfies positive-skew criteria for adjusting one or more components of an in-line drying tunnel, determining at least one produce-drying adjustment to at least one of the components of the in-line drying tunnel based on a determination that the skewness metric satisfies the positive-skew criteria, generating instructions to adjust the at least one of the components according to the determined at least one produce-drying adjustment, and executing the instructions in real-time while the one or more batches of produce pass through the in-line drying tunnel to automatically adjust the at least one of the components. The batch of produce can pass through the in-line drying tunnel as part of the produce preparation process before being imaged by the imaging device. Satisfying the positive-skew criteria can indicate that the batch of produce has a threshold level of wetness upon exiting the in-line drying tunnel. The produce-drying adjustment may include at least one of: increasing a temperature control inside the in-line drying tunnel by a threshold temperature amount, increasing a convection control inside the in-line drying tunnel by a threshold convection amount, increasing a residence time of the one or more batches of produce inside the in-line drying tunnel by a threshold amount of time, and increasing a speed by which the one or more batches of produce are moved, by an automated conveyor system, through the in-line drying tunnel.

In yet some implementations, the method can also include iteratively: receiving a skewness metric for the one or more batches of produce, determining whether the skewness metric satisfies the positive-skew criteria, determining at least one produce-drying adjustment to at least one of the components of the in-line drying tunnel based on a determination that the skewness metric satisfies the positive-skew criteria, generating instructions, and executing the instructions in real-time.

The method can also include determining at least one energy-usage adjustment to at least one of the components of the in-line drying tunnel based on a determination that the skewness metric does not satisfy the positive-skew criteria. The positive-skew criteria may not be satisfied when, based on the dryness metric, the batch of produce is burnt upon exiting the in-line drying tunnel. The energy-usage adjustment can include at least one of: decreasing the temperature control inside the in-line drying tunnel by a threshold temperature amount, decreasing the convection control inside the in-line drying tunnel by a threshold convection amount, decreasing the residence time of the one or more batches of produce inside the in-line drying tunnel by a threshold amount of time, and decreasing the speed by which the one or more batches of produce are moved, by an automated conveyor system, through the in-line drying tunnel. The method can also include generating instructions to adjust the at least one of the components according to the determined at least one energy-usage adjustment, and executing the instructions in real-time while the one or more batches of produce pass through the in-line drying tunnel to automatically adjust the at least one of the components. Sometimes, the method includes determining, by the computing system, the skewness metric based on the distribution characteristics of the extracted temperature values for the batch of produce.

The devices, system, and techniques described herein may provide one or more of the following advantages. For example, the disclosed technology provides techniques for accurately determining dryness of produce, regardless of ambient conditions that may otherwise affect absolute temperature values of the produce. Machine learning trained models can be used to more accurately determine dryness of the produce from thermal image data by correlating temperature distribution characteristics (e.g., skewness of temperature values) of the produce to a dryness metric. By determining surface dryness of the produce early in the supply chain, actions can be determined and made to optimize and improve a drying process for the produce. As a result, well-coated (e.g., with the shelf life extension coating solution) produce can be sufficiently and fully dried to remove surface moisture such that the produce can be moved to a next process or stage in the supply chain without causing downstream problems in the supply chain.

As another example, the disclosed technology can be used to make appropriate supply chain modifications early enough in the supply chain to optimize and improve application of the shelf life extension coating solution so that well-coated produce can be shipped to a next stage in the supply chain. The shelf life extension coating solution can be better cured, having improved gas and water barrier properties. Moreover, improving the shelf life extension coating solution, applying the solution to the produce, and fully drying the produce after the application can provide for the shelf life extension coating solution to remain on the produce rather than being wiped off the produce downstream in processing.

As described throughout, the disclosed technology can generate more robust quality assessments of produce, particularly with respect to a dryness metric. Different models can be generated and trained using machine learning techniques and high quality labeled training data sets in order to identify and score dryness as it corresponds to different types of produce.

As yet another example, the disclosed technology provides for accurately assessing dryness of produce based on surface temperature of the produce and without reducing quality of the produce. The models can be trained to extract temperature values from the image data, determine skewness of those values, and use skewness to infer a dryness metric while the produce is routed through a processing or storage facility and before the produce is delivered to end consumers.

The disclosed technology can also be applied in a variety of settings. For example, and as described herein, the disclosed technology can be used to determine dryness of produce, such as fruit and vegetables. The disclosed technology can also be applied to determine dryness of any other item having a liquid coating applied to its outer surface and that goes through some drying process. The other item, for example, can include metal products, such as pipes.

Moreover, the disclosed technology requires a single input to accurately assess and determine dryness of produce. This can improve efficiency of model execution, improve accuracy in model predictions, and reduce an amount of processing power required to perform the disclosed techniques.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of determining produce dryness based on image data.

FIG. 1B is a conceptual diagram of generating models to determine dryness of different types of produce.

FIGS. 2A-B is a flowchart of a process for determining a dryness metric for a batch of produce based on temperature distribution characteristics.

FIG. 2C is a flowchart of a process for determining a dryness metric for a batch of produce based on dry and wet features.

FIG. 3 is a block diagram of a pipeline for determining produce dryness.

FIG. 4A is a swimlane diagram of a process for determining a dryness metric for imaged produce.

FIG. 4B is a system diagram of components that can be used to perform the disclosed techniques.

FIG. 5 is a flowchart of a process for determining skewness of temperature values for imaged produce.

FIG. 6 is a flowchart of a process for determining skewness and correlating the skewness to a dryness metric for a batch of produce.

FIGS. 7A1 and 7A2 depict graphs exemplifying correlations between skewness and a dryness metric.

FIG. 7B shows an example equation for determining a linear fit through the points plotted in the graph in FIG. 7A1.

FIG. 7C depicts a histogram of temperature values for determining a dryness metric for produce based on skew of the temperature values.

FIG. 8 is a schematic diagram that shows an example of a computing device and a mobile computing device.

FIG. 9 is a flowchart of a process for adjusting a produce preparation system.

FIGS. 10A-B are illustrative examples of a produce preparation system.

Like reference symbols in the various drawings indicate like elements.

### DETAILED DESCRIPTION OF ILLUSTRATIVE EMBODIMENTS

This document generally relates to systems, methods, techniques, and computer programs for assessing dryness of produce from image data, such as thermal image data. The disclosed technology can provide for obtaining image data of a batch of produce and determining, based on an evaluation of the image data, a dryness metric for the batch of produce. The dryness metric can be on a predetermined scale from 0 to 3, where 0 can be fully dry and 3 can be fully wet. One or more other scales can also be used. Models can be trained using machine learning techniques to process the image data, identify temperature values of produce in the image data, determine a skew of the temperature values, and predict a dryness metric for the produce. Skewness can also be referred to as temperature distribution characteristics throughout this disclosure. As described herein, models can be dynamically selected based on a type of the produce depicted in the image data, a place of origin of the produce, environmental conditions, and other factors to develop accurate dryness assessments of such produce. Moreover, the determined dryness metric for the batch of produce can be used to modify one or more supply chain operations, such as a formula for a shelf life extension coating solution and/or other produce preparation processes (produce drying processes). As a result, the disclosed technology can provide for mitigating losses that may arise from produce having a level of dryness that fails to satisfy certain thresholds and thus causes the produce to be lower quality when delivered to end consumers.

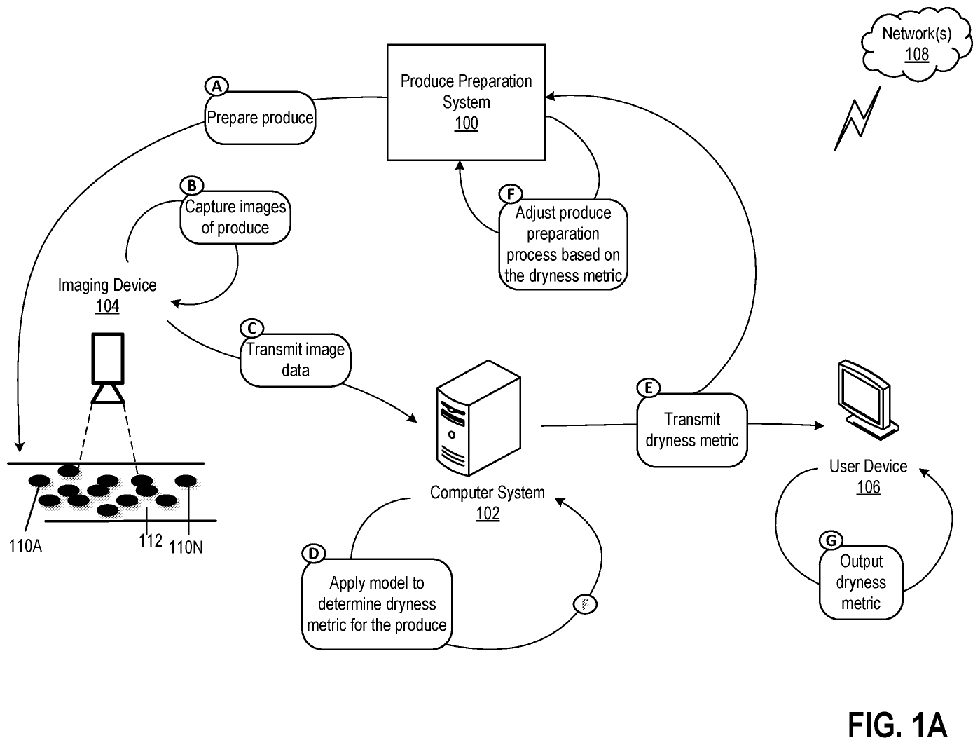

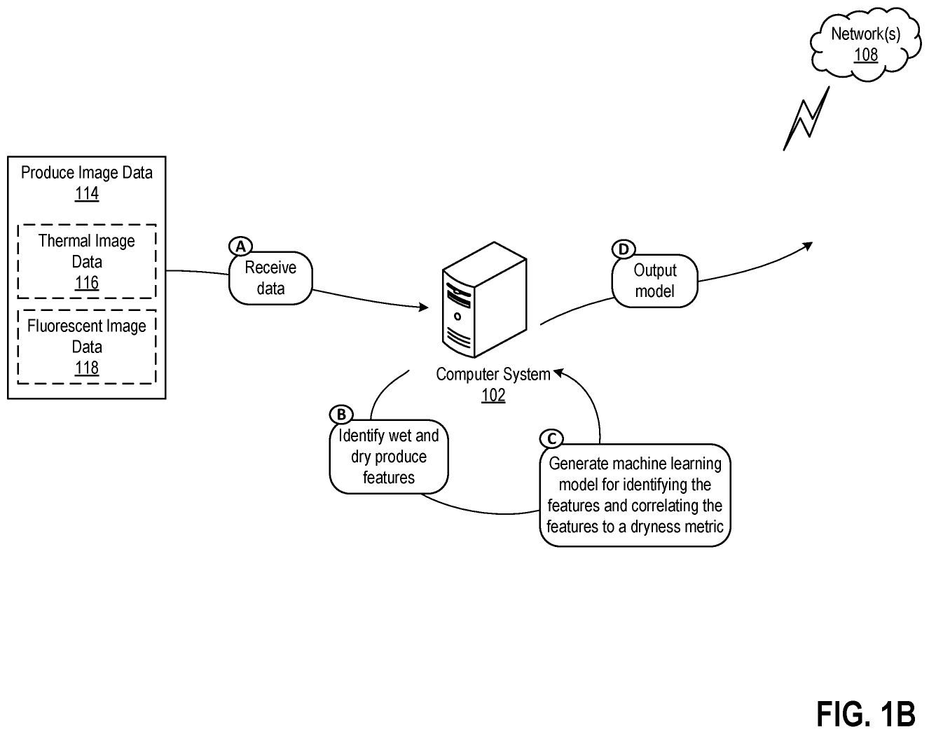

Referring to the figures, FIG. 1A is a conceptual diagram of determining produce dryness based on image data. A computer system 102, imaging device 104, and user device 106 can be in communication (e.g., wired and/or wireless) via network(s) 108. The computer system 102 can be configured to assess dryness of imaged produce 110A-N, as described throughout this disclosure. The imaging device 104 be a thermal imaging device (e.g., thermal imaging camera) that can capture thermal image data of the produce 110A-N. The imaging device 104 can be placed in a storage facility, warehouse, or any other location along a supply chain. For example, the imaging device 104 can be positioned over and/or adjacent to a conveyor belt 112 in a storage facility. The produce 110A-N can be routed through the storage facility by the conveyor belt 112 and thus imaged by the imaging device 104.

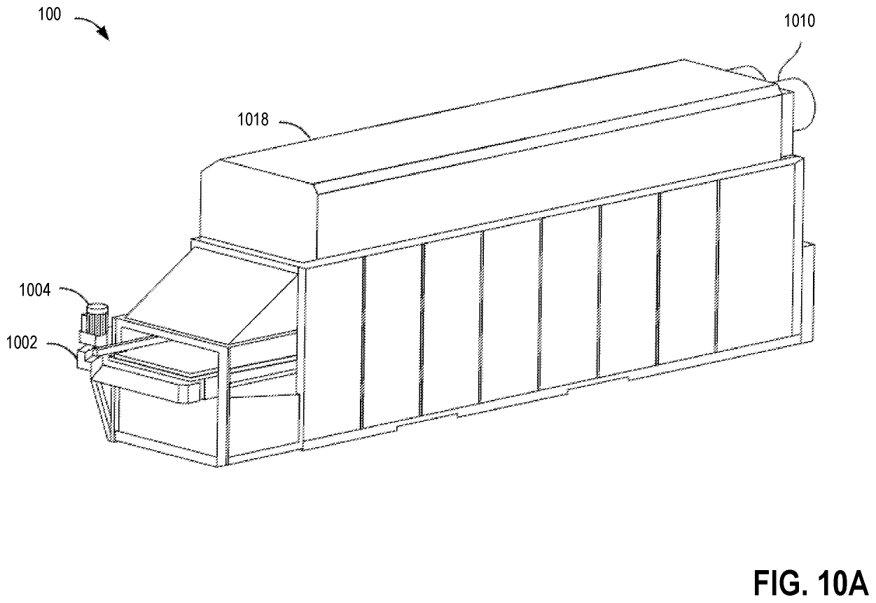

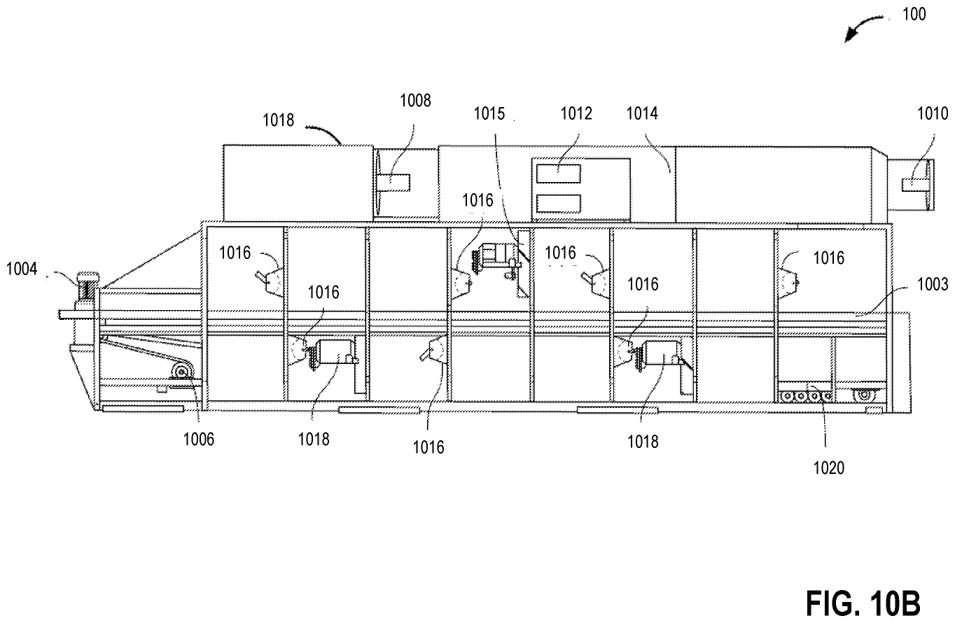

Before and/or while the produce 110A-N is routed through the storage facility by the conveyor belt 112, the produce 110A-N can be prepared by a produce preparation system 100 (block A). The produce preparation system 100 can include an applicator that coats the produce 110A-N in a shelf life extension coating solution. The produce preparation system 100 can also include one or more other systems, such as a drying tunnel and/or a heating/heat tunnel (e.g., convective heating tunnel). Refer to FIGS. 10A-B for further discussion about the produce preparation system 100. The produce preparation system 100 can prepare the produce 110A-N for transit to end consumers by coating the produce 110A-N in a formula of the shelf life extension coating solution unique to the particular produce type and passing the produce 110A-N through the drying tunnel and/or the heating tunnel so that the produce 110A-N can dry after application of the shelf life extension coating solution and maintain a level of quality while in transit to end consumers. After all, to obtain preferred, or beneficial performance of the shelf life extension coating solution, the produce 110A-N should be fully dry after the preparation process in block A.

The imaging device 104 can be configured to continuously capture image data of produce 110A-N as it is moved along the conveyor belt 112 to one or more storage locations, other destinations within the storage facility, and/or trucks or other shipping containers for transit to end consumers (block B). The image data can be thermal image data. The image data can be captured after the produce 110A-N is prepared by the produce preparation system 100. Due to evaporative cooling, as the produce 110A-N exits the drying tunnel, for example, portions of the produce 110A-N that still have a layer of liquid can be relatively colder than areas that are fully dry. The image data can capture temperature values of these portions of the produce 110A-N, which can be used by the computer system 102 to determine a dryness metric for the produce 110A-N, described further below.

In some implementations, the image data can be captured before the produce 110A-N is prepared by the produce preparation system 100 in block A. As a result, a dryness metric for the produce 110A-N can be determined first and then used by the produce preparation system 100 to generate or modify a preparation process for the produce 110A-N. The generated or modified preparation process can then be applied to the produce 110A-N.

Referring to block B, the produce 110A-N can include, but is not limited to, fruits and vegetables, such as avocados, apples, lemons, limes, berries, mangos, and other food items that can be entering and kept in a storage facility. The produce 110A-N can be on a tray, pallet, and/or in a monolayer in a case/container placed directly on the conveyor belt 112. In some implementations, the produce 110A-N may be static or otherwise not being moved on the conveyor belt 112 in the storage facility. For example, some of the produce 110A-N can be sampled randomly and then analyzed by the computer system 102 to obtain an estimation of the dryness metric for a batch of the produce 110A-N.

The imaging device 104 can transmit the image data to the computer system 102 (block C). The computer system 102 can then apply one or more models to the image data in order to determine a dryness metric for the produce 110A-N (block D). The computer system 102 can determine the dryness metric by determining a skew of temperature distributions in the image data and correlating the skew to a numeric value indicative of dryness. For example, a machine learning trained model can receive temperature values from pixels in the image data as input. The model can be trained to determine the skew of the temperature values and predict a dryness metric based on the skew. The model can output the determined dryness metric. This process, as described throughout this disclosure, can accurately determine dryness of the produce 110A-N regardless of fluctuations in environmental conditions (e.g., air temperature, humidity level, etc.) in the storage facility since the disclosed techniques analyze temperature distribution features, not absolute temperature values of the produce 110A-N.

In some implementations, and/or alternatively, the computer system 102 can apply the model(s) to the image data to identify dry and wet features in the produce 110A-N, which can then be used to determine the dryness metric for the produce 110A-N. As described herein, the model(s) can be trained using machine learning techniques to identify dry and wet features of different types of produce. The model(s) can then map the identified dry and wet features to the dryness metric. For example, the model(s) can determine an absolute temperature value for each of the identified dry and wet features. The model(s) can be trained to determine that the produce 110A-N is dry if the absolute temperature value(s) is above a threshold temperature value and the produce 110A-N is wet if the absolute temperature value(s) is below the threshold temperature value. Moreover, in some implementations, the computer system 102 can identify the dry and wet features of the produce 110A-N using the disclosed techniques in order to calibrate the model(s) that is used to determine the skew and correlate the skew to the dryness metric.

Still referring to block D, the computer system 102 can select one or more models to apply based at least in part on the type of produce 110A-N identified in the image data and other information about the produce 110A-N, such as a location of origin and/or ambient/environmental conditions. Moreover, although the techniques described herein can be applied to the image data to determine dryness of a batch of the produce 110A-N, the computer system 102 can also apply the models to each of the produce 110A-N identified in the image data to determine dryness of each of the produce 110A-N. Sometimes, the computer system 102 can determine dryness of each of the produce 110A-N then aggregate those dryness determinations to determine a dryness of the batch of the produce 110A-N.

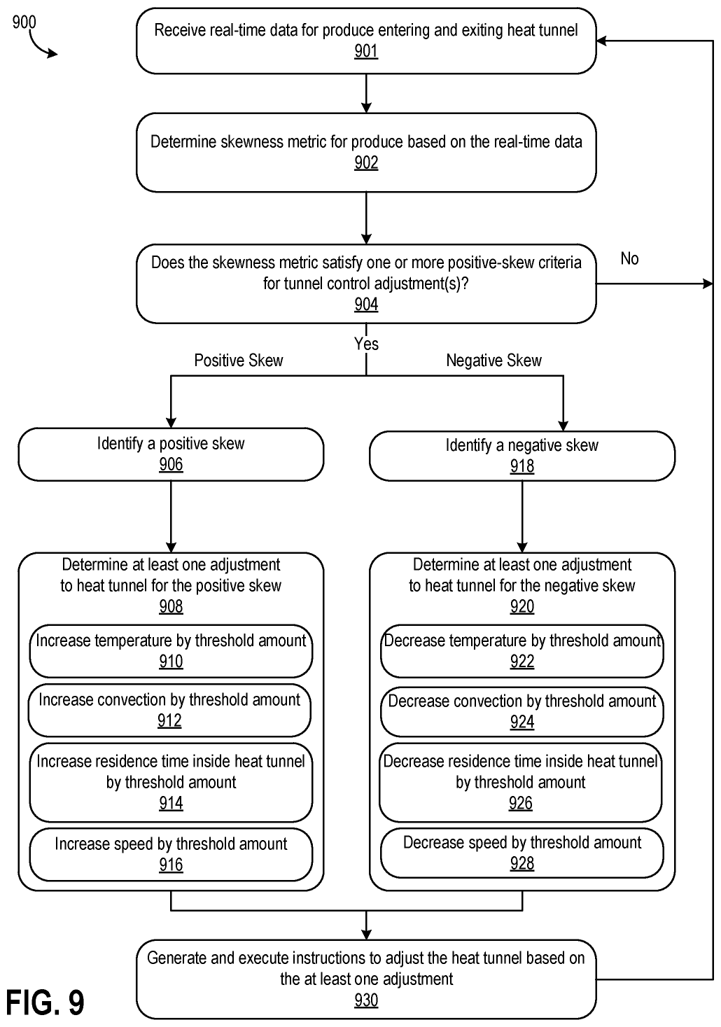

The computer system 102 can transmit the dryness metric for the batch of produce 110A-N to the produce preparation system 100 and/or the user device 106 in block E. The produce preparation system 100 can modify, adjust, and/or generate produce preparation process(es) based on the dryness metric (block F). In some implementations, the computer system 102 can adjust the produce preparation process based on the dryness metric (block F). The computer system 102 can execute one or more of the adjustments and/or cause a controller of the produce preparation system 100 to execute the adjustments in real-time. The computer system 102 can determine one or more real-time, in-line adjustments to make to temperature and/or airflow of the produce preparation system 100. As another example, the computer system 102 can determine one or more real-time, in-line adjustments to make to a residence time of other produce inside the produce preparation system 100 and/or a speed at which the other produce moves through the produce preparation system 100. Refer to FIG. 9 for further discussion about adjusting the produce preparation process.

As mentioned above, the produce preparation processes can include, but is not limited to, dryer temperature set points, other dryer parameters such as fresh air intake, shelf life extension coating solution application factor(s) (e.g., formula, application process, etc.), dryer throughput, and/or conveyor belt speed. In some implementations, the produce preparation system 100 can then prepare a next batch of the same type of produce as the produce 110A-N using the modified, adjusted, and/or generated produce preparation process(es) (block A). In some implementations, the disclosed techniques can be used in a continuous or semi-continuous process such that minor and/or incremental modifications can be implemented in real-time to the produce preparation process(es).

Once the dryness metric for the produce 110A-N is transmitted to the user device 106, the user device 106 can output the dryness metric (block G). The user device 106 can be a mobile device, smartphone, tablet, laptop, or other computer that can be used by a relevant stakeholder in the supply chain. The stakeholder can view the dryness metric for the produce 110A-N in order to determine changes to a produce preparation process for that type of produce. As described herein, upstream processing parameters can be updated (e.g., application rate of the shelf life extension coating solution, conveyor belt speed, dryer temperature, etc.) to provide for more consistently coated and dried produce.

The stakeholder can also view the dryness metric for the produce 110A-N to determine other supply chain modifications. For example, the stakeholder can determine how the produce 110A-N can be used based on its dryness metric (e.g., whether the produce 110A-N should be stored in the storage facility for a while longer until it dries enough for transport, whether the produce 110A-N should be immediately transported to end consumers before a quality of the produce 110A-N decreases, whether the produce 110A-N has enough surface defects to be considered bad and thus not shipped to end consumers, etc.). Accordingly, the dryness metric can be used by the relevant stakeholder to understand or analyze a return on investment (ROI) for the produce 110A-N (for example, using the disclosed techniques can result in a smaller percentage of the produce 110A-N being rejected downstream in the supply chain for not having stickers adhered thereto, thereby improving the ROI) and equipment, such as dryers (for example, by turning dryer temperatures down, gas money for the dryers can be saved, thereby improving the ROI), monitor quality of the produce 110A-N over time, and/or optionally make one or more supply chain modifications based on the dryness of the produce 110A-N.

In some implementations, the computer system 102 can also transmit the dryness metric to a database for storage. The dryness metric can be stored with historical measurements and/or metadata associated with the produce 110A-N. This stored information can be used in a feedback loop for continuous improvement and training of the machine learning models that are used to perform the techniques described herein. For example, using previously determined dryness metrics, one or more higher level models can be improved and/or trained to identify dryness based on a variety of factors, including but not limited to seasonality, variety, size, and country or location of origin.

FIG. 1B is a conceptual diagram of generating models to determine dryness of different types of produce. As described throughout this disclosure, models can be generated for different types of produce and based on a variety of different factors, such as location of origin, environmental conditions, seasonality, variety, size, etc. In FIG. 1B, the computer system 102 can train one or more models to determine dryness based on identifying dry and wet features of produce from image data.

The computer system 102 can receive produce image data 114 in block A. The produce image data 114 can be received from one or more imaging devices, such as the imaging device 104 described in FIG. 1A. The produce image data 114 can optionally include thermal image data 116 and/or fluorescent image data 118 (e.g., visible spectrum or other types of image data) depicting a particular produce, produce type, different produce, different produce types, a single produce, and/or a batch of produce.

The produce image data 114 can include images, tables, and/or other data of a particular produce having some particular feature to be modeled, such as dry and wet spots, and images of the same type of produce that does not have the particular feature(s) to be modeled. For example, the produce image data 114 can include tables that are stored in a data store containing dry and wet spots that have been extracted from images of the produce and labeled/annotated as such.

The produce image data 114 can be a robust collection of training data indicating a plurality of dry and wet that may exist for the particular produce throughout the produce's lifecycle. The produce image data 114 can be, for example, a collection of images of the same produce from different angles, such that the entire produce can be analyzed fully using the techniques described herein. Moreover, in some implementations, the produce image data 114 can include labels for dry and wet spots on the produce. In yet some implementations, such features can be learned using produce image data 114 that does not include labels/annotations.

In block B, the computer system 102 can identify wet and dry features of the produce from the produce image data 114. For example, the computer system 102 can process the produce image data 114 and perform object detection techniques to identify locations of each produce in the produce image data 114 with a bounding box. Pixels can be sampled from each bounding box and broken down to discretized colors to identify dry and wet areas of the produce. Splotchy, darker areas of the produce in some of the produce image data 114 can be associated with wet areas of the produce while lighter areas of the produce in the produce image data 114 can be associated with dry areas of the produce. One or more other temperature color schemes can also be used. Moreover, depending on the imaging device settings, there can be distinct visible differences between hot and cold (dry and wet, respectively) areas on a surface of the imaged produce. The dry areas of the produce may also be associated with higher temperature values and the wet areas of the produce may be associated with lower temperature values.

In block C, the computer system 102 can generate a machine learning model for identifying the wet and dry features of the produce and correlating those features to dryness of the produce. The model can therefore be trained to determine a dryness metric of the produce based on temperature values of the identified wet and dry features in the produce image data 114.

The model can be generated and/or trained by one or more other computing systems, computers, networks of devices, and/or cloud-based services. The model can, for example, be trained by a remote computer system, such as a cloud-based computing system, stored in a data store, and therefore accessible by the computer system 102 for runtime execution. The model can be generated using machine learning techniques, including but not limited to CNNs, neural networks, etc. One or more other machine learning techniques can be used to generate and train the model.

Finally, the computer system 102 can output the model in block D. During runtime use, the generated model can be applied to image data of produce to determine a dryness metric for the imaged produce.

In some implementations, the techniques described in FIG. 1B can also be used to train a model to determine the dryness of produce based on temperature distribution characteristics, like skewness. For example, the computer system 102 can receive the produce image data 114 in block A. In block B, the computer system 102 can perform object detection techniques to identify produce in the image data 114 and extract temperature values from pixels in the identified produce. In block C, the computer system 102 can generate a machine learning model for determining a skew of the extracted temperature values and correlating the skew to a dryness metric of the produce. The computer system 102 can then output the model in block D, as described above.

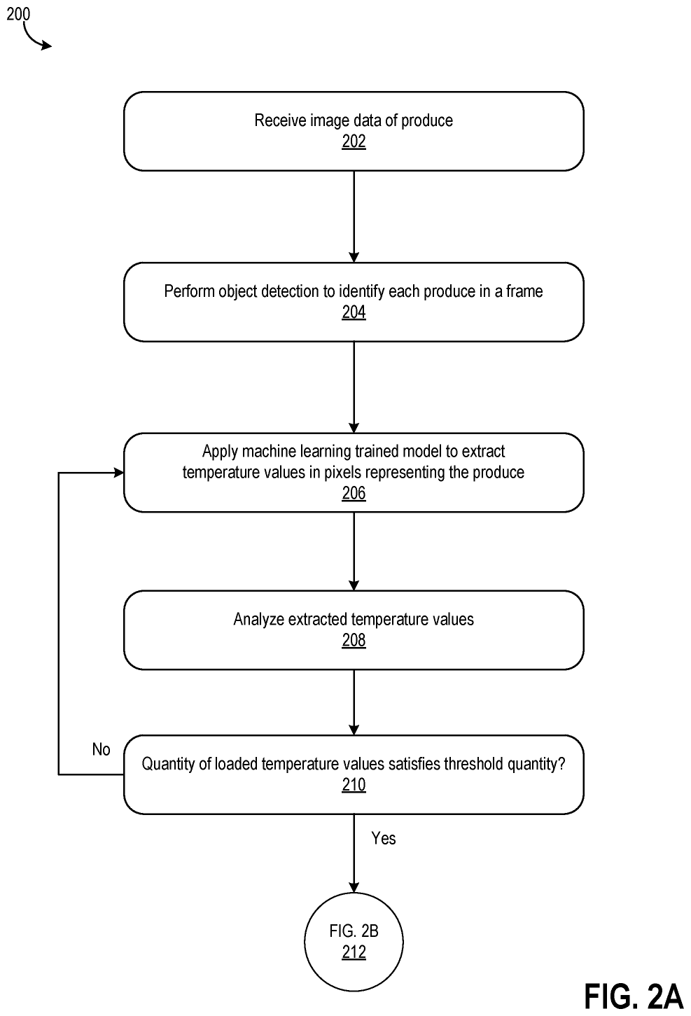

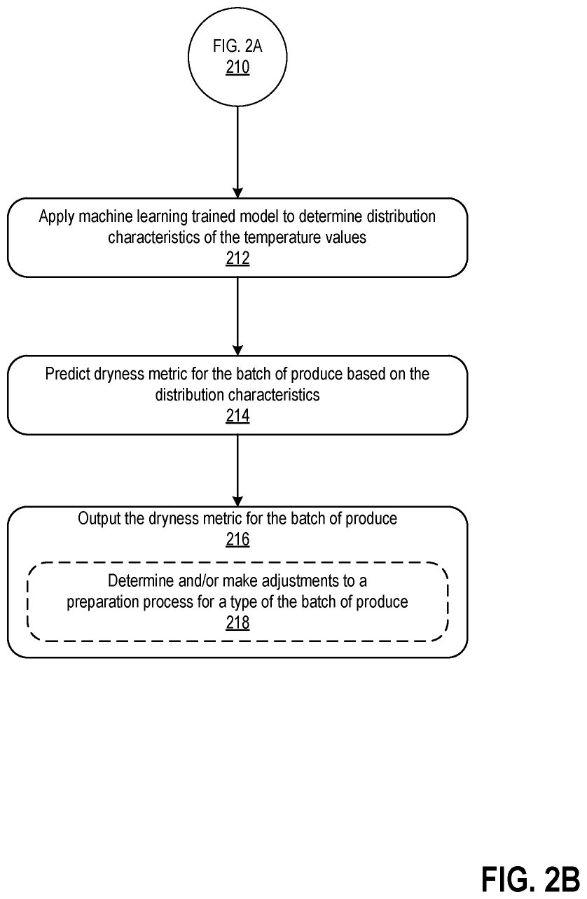

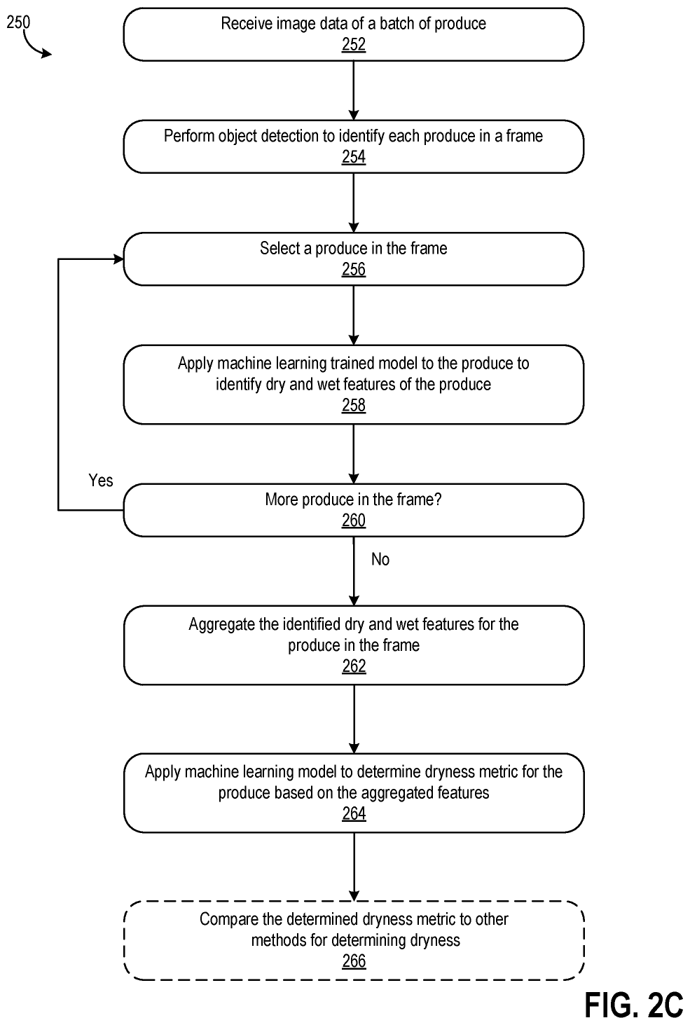

FIGS. 2A-B is a flowchart of a process 200 for determining a dryness metric for a batch of produce based on temperature distribution characteristics, like skewness. The process 200 can be performed by the computer system 102. The process 200 can also be performed by one or more other computing systems, devices, computers, networks, cloud-based systems, and/or cloud-based services. For illustrative purposes, the process 200 is described from the perspective of a computer system.

Referring to the process 200 in both FIGS. 2A-B, the computer system can receive image data of a batch of produce in block 202. As described throughout, the image data, which can be thermal image data, can be received from an imaging device. The image data can also be retrieved from a database, data store, or other repository storing image data of a particular produce. The image data can include images of the particular produce or consecutive batch of multiple produce whose dryness is supposed to be determined.

In block 204, the computer system can perform object detection techniques to identify each produce in the batch. The computer system can use a generic object detection model to find all bounding boxes around produce in the image data. The generic object detection model can be trained to detect any type of produce with high accuracy.

The computer system can also apply a machine learning trained model to extract temperature values in pixels representing the identified produce in block 206.

The computer system can then analyze the extracted temperature values in block 208 (e.g., process the extracted temperature values). In some implementations, block 208 can include loading the extracted temperature values into a histogram. The extracted temperature values can also be loaded into one or more other types of distributions of temperature values.

The computer system can determine whether a quantity of loaded temperature values satisfies a threshold quantity in block 210. If the quantity of loaded temperature values does not satisfy the threshold quantity, then the computer system can return to block 206 and continue processing more frames until enough temperature data (e.g., temperature values) is extracted to satisfy the threshold quantity. If the quantity of loaded temperature values satisfies the threshold quantity in block 210, the computer system can proceed to block 212.

In block 212, the computer system can determine distribution characteristics of the temperature values. For example, the computer system can determine distribution characteristics of the temperature values that have been loaded into a histogram or other type of distribution of temperature values. In some implementations, the computer system can apply one or more machine learning trained models to determine the distribution characteristics, like skewness. The model(s) can be different than the model applied in block 206. In some implementations, the model(s) applied in block 212 can be the same as the model applied in block 206.

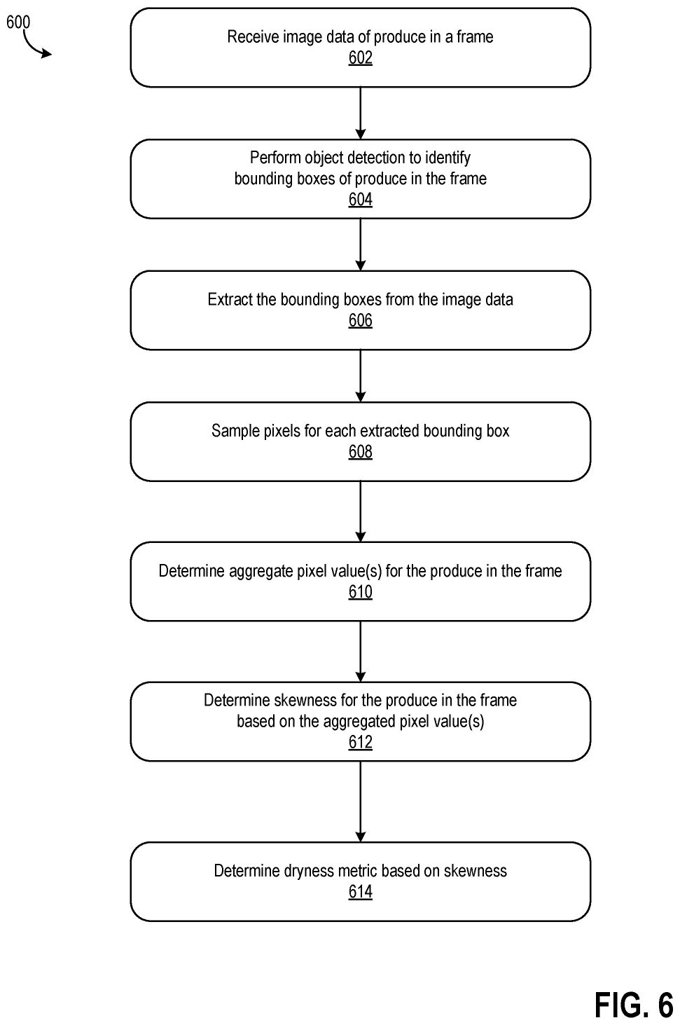

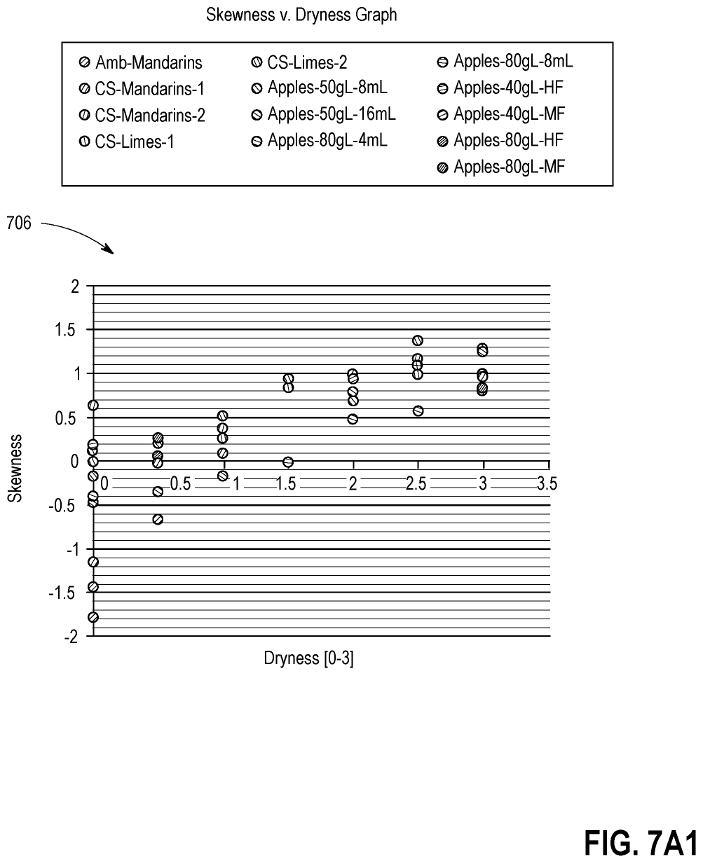

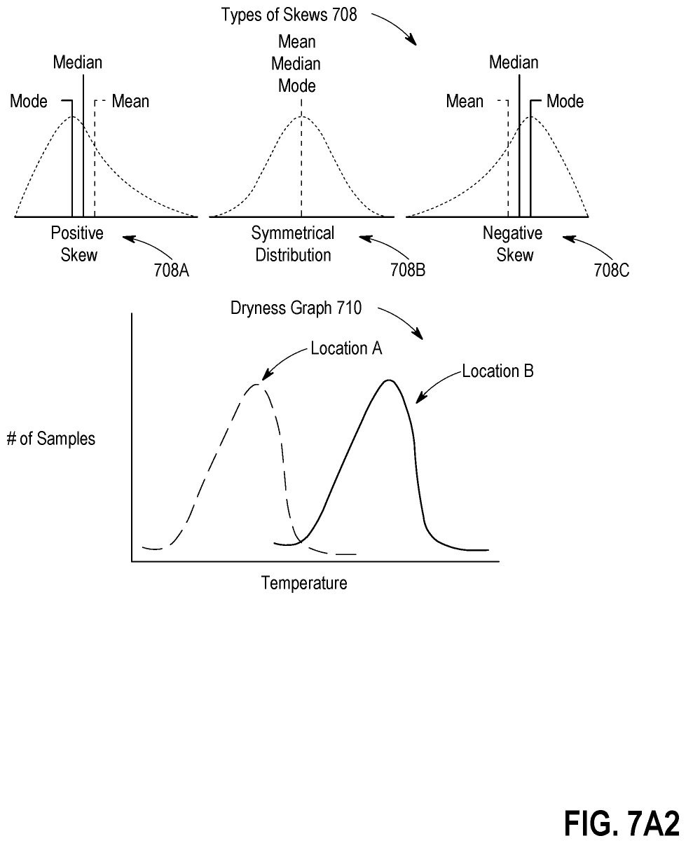

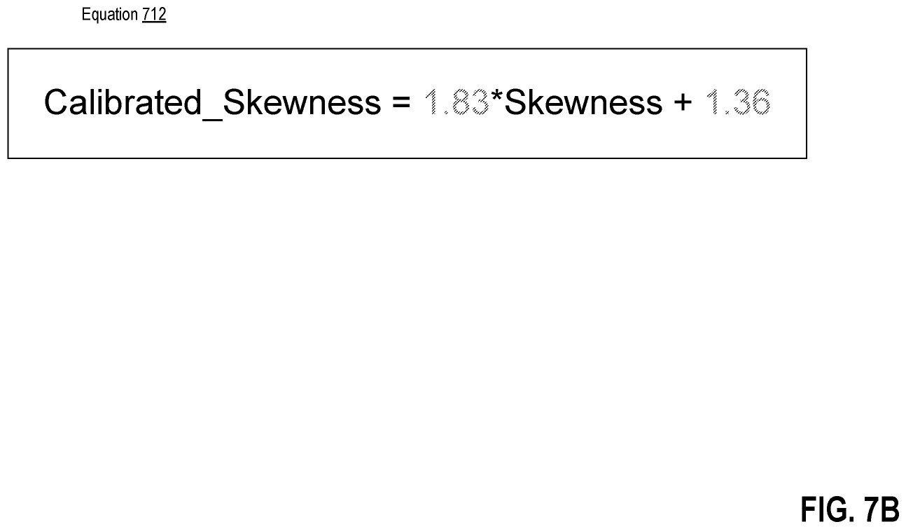

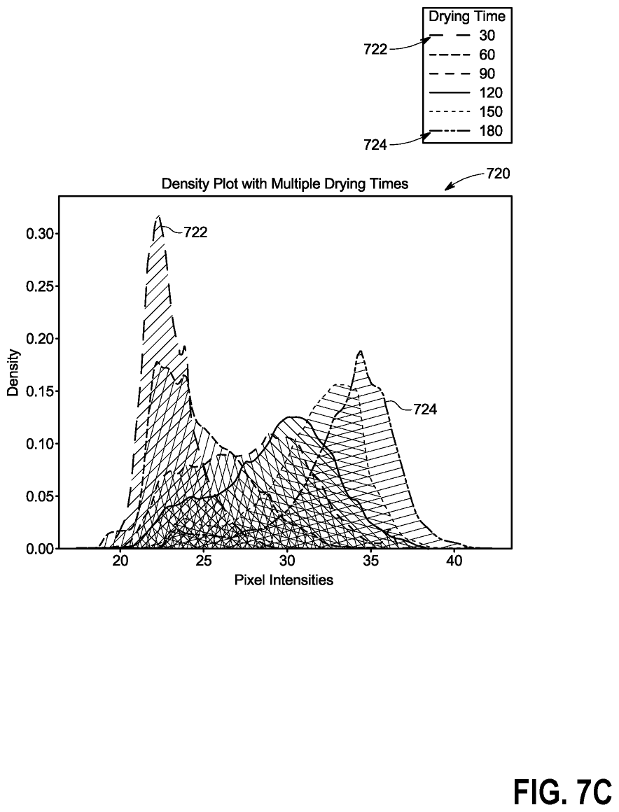

Skewness is a measure of asymmetry of distribution of a variable, such as temperature values, about its mean. The computer system can determine how much temperature values for the batch of produce skew either positively or negatively. The computer system can determine a mode, median, and mean for the average temperature values for the batch of produce. The mode can indicate a most popular temperature for the batch. The median can represent a middle temperature across all the temperature values for the batch. The mean can represent an average temperature for the batch. The computer system can then graph these values as a histogram, line graph, or other graphical depiction to identify and determine the skewness metric for the batch of produce. The skewness metric is a calculation that has a variable of mode, median, and/or mean for the temperature values for the batch of produce, depending on an equation or formula that is used. The skewness metric is a calculated value. Refer to FIGS. 6 and 7A1-C for additional discussion on determining the skewness metric.

The computer system can then apply a skewness to dryness model to output the dryness metric. Therefore, the computer system can predict the dryness metric for the batch of produce using the model and based on the distribution characteristics (block 214). A same skewness to dryness model can be used to output the dryness metric, regardless of one or more factors that may be unique to a particular type of produce and/or a processing or storage facility.

In some implementations, however, various empirical models can be generated using machine learning techniques, where each model can predict the dryness metric based on skewness and further based on factors unique to a particular type of produce, a processing or storage facility, and/or one or more other factors. For example, a model can be generated to predict the dryness metric based on produce type. Another model can be generated to predict the dryness metric based on ambient, environment, and/or geographic conditions where the produce is being imaged. Yet another model can be generated to predict the dryness metric based on a configuration and configuration settings of a produce preparation system (e.g., a set up configuration of a drying tunnel, a temperature inside the drying tunnel, an amount of time that produce is placed in the drying tunnel, etc.). One or more additional or fewer models can be generated based on other factors to accurately predict the dryness metric.

For example, a negative skew can be correlated with a higher level of dryness than a positive skew. Scaling the skewness metric to the dryness metric can include assigning a numeric value as the dryness metric. The greater the skewness metric, the greater the dryness metric (e.g., refer to FIG. 7A1 and FIG. 7A2). The numeric value can be assigned on some predetermined scale. The predetermined scale can be any range of numeric values. For example, the predetermined scale can be a continuous scale of 0 to 3, where 0 can be fully dry and 3 can be fully wet. One or more other ranges of values can be used for the dryness metric.

In some implementations, blocks 212-214 can be performed by the machine learning trained model and the dryness metric can be output from the model.

In block 216, the computer system can output the dryness metric for the batch of produce. As described herein, the computer system can store the dryness metric in a data store for future retrieval, processing, and/or analysis. The computer system can also transmit the dryness metric to a user device. The computer system can also transmit the dryness metric to a produce preparation system. Refer to FIG. 1A for additional discussion about block 216.

In some implementations, the computer system can optionally determine and/or make adjustments to a preparation process for a type of the batch of produce (block 218). In some implementations, adjustments to the preparation process can be made by the produce preparation system 100. Refer to FIG. 1A for additional discussion about block 218.

FIG. 2C is a flowchart of a process 250 for determining a dryness metric for a batch of produce based on dry and wet features. The process 250 can be performed by the computer system 102. The process 250 can also be performed by one or more other computing systems, devices, computers, networks, cloud-based systems, and/or cloud-based services. For illustrative purposes, the process 250 is described from the perspective of a computer system.

Referring to the process 250 in FIG. 2C, the computer system can receive image data of a batch of produce in block 252. Refer to block 202 in the process 200 of FIGS. 2A-B. The computer system can perform object detection techniques to identify each produce in a frame of the image data in block 254. Refer to block 204 in the process 200 of FIGS. 2A-B. In block 256, the computer system can select a produce in the frame. For example, the computer system can select a bounding box around one of the produce that was identified in block 254.

The computer system can apply a machine learning trained model to the selected produce to identify dry and wet features of the produce (block 258). The model can be trained to identify absolute temperature values in the image data and then identify dry and wet regions on an individual produce in the image data based on the identified absolute temperature value(s). The computer system can identify the dry and wet features using the techniques described in reference to block D in FIG. 1A. In some implementations, the computer system can select which model to apply based on the image data received in 252. For example, the computer system can identify a type of produce that is captured by the image data using object recognition techniques. The computer system can then retrieve a model associated with the identified type of produce from a data store or other database that stores generated models. In some implementations, the computer system can use metadata that is part of the image data about the produce (e.g., country, produce type, etc.) to determine which model to retrieve. The model can be applied to the bounding box of the selected produce to determine dry and wet spots of the selected produce.

The computer system can determine whether there are more produce in the frame in block 260. In other words, the computer system can check for more bounding boxes. If there are more produce, the computer system can return to bock 256 and repeat block 258 for each remaining produce in the batch. If there are no more produce in the batch to further analyze in block 260, the computer system can proceed to block 262.

In block 262, the computer system can aggregate the identified dry and wet features for the produce in the frame. For example, the model can identify and extract temperature values from pixels representative of the dry and wet features of the produce. Aggregating the dry and wet features can include averaging the temperature values for dry features that were identified in produce in the batch and averaging the temperature values for wet features that were identified in produce in the batch. The computer system can therefore determine an average absolute temperature value for the produce based on aggregating the temperature values for the dry and wet features.

In block 264, the computer system can apply a machine learning trained model to determine a dryness metric for the produce based on the aggregated dry and wet features. For example, the model can determine and output a dryness metric that corresponds to a dryer condition of the produce if the aggregated dry and wet features exceeds a threshold temperature value. The model can determine and output a dryness metric that corresponds to a wetter condition of the produce if the aggregated dry and wet features is less than a threshold temperature value. The model can be the same or different than the model applied in block 258.

Optionally, the computer system can compare the determined dryness metric to other methods for determining dryness. The other methods for determining dryness can include a skewness model, as depicted and described in reference to FIGS. 2A-B (block 266). In some implementations, the computer system can calibrate a skewness model based on the determined dryness metric in block 266. The computer system can use the dryness metric determined in the process 250 to calibrate and further refine/improve the model(s) used in the process 200 of FIGS. 2A-B (e.g., refer to block 212) and described throughout this disclosure.

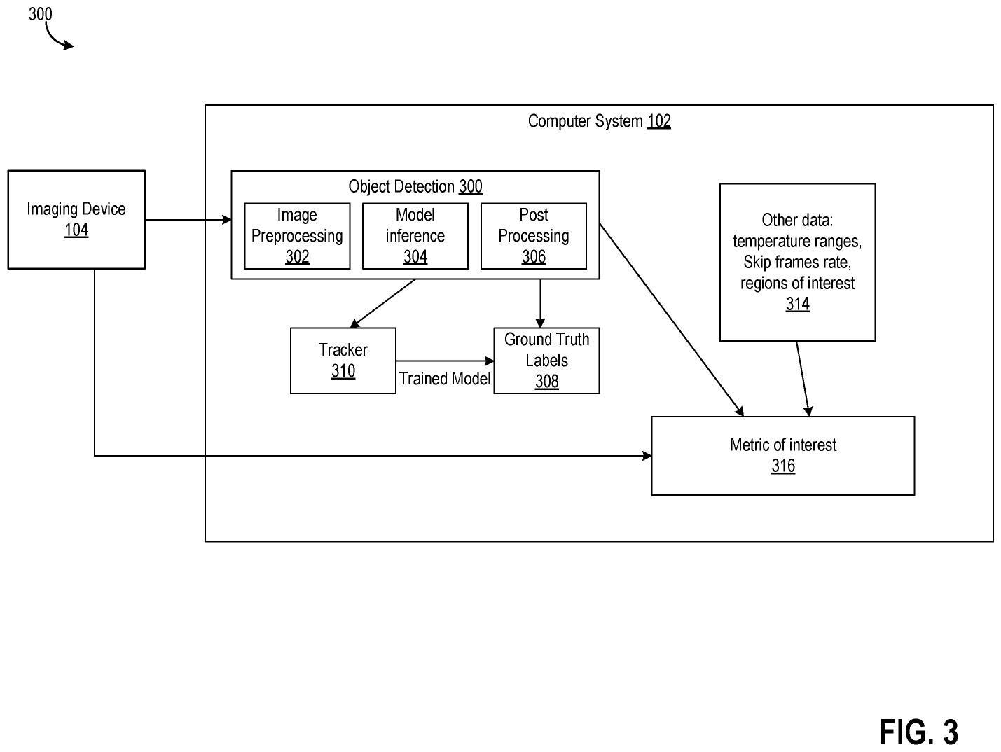

FIG. 3 is a block diagram of a pipeline 300 for determining produce dryness. Aspects of the pipeline 300 can be performed by the computer system 102, as described throughout this disclosure. The pipeline 300 can be broken down into two parts: object detection 300 and metric of interest 316. The pipeline 300 is similar to the process 250 described in FIG. 2C.

Referring to the pipeline 300, the imaging device 104 can capture image data of the produce. The image data can be transmitted to the computer system for object detection 300. An object detection API can be used in combination with a produce tracker 310 to preprocess 302 the image data, generate model inferences 304, and perform post processing 306 on the image data. The image data can be preprocessed 302 using various techniques such as histogram equalization. Preprocessing 302 can be beneficial to improve detection of objects in the image data. Model inferences can be generated 304 as part of the object detection 300, in which bounding box coordinates can be computed. Post processing 306 can include extracting necessary information from raw model outputs for next steps in the pipeline 300. The image data can also be passed through the tracker 310 and a machine learning trained model can be applied to the image data to determine ground truth labels 308 for the image data.

In some implementations, during object detection 300, the computer system 102 can extract individual produce from the image data in bounding boxes, identify the individual produce, assign each of the produce a unique identifier, and track the produce as they move through a frame or frames in the image data received from the imaging device 104. During object detection 300, the bounding box coordinates for each produce can be stored in a data store. This stored information can be passed down to other components of the computer system 102 to perform other downstream processes, such as determining the metric of interest 316.

The computer system 102 can use the stored bounding box information and other data 314 to determine a metric of interest 316. The metric of interest 316 can be, as described throughout this disclosure, a dryness metric and/or a skewness. The other data 314 can be used to customize processing of the particular image data. Accordingly, the other data 314 can include temperature ranges (e.g., to what temperature range a gray scale image should be mapped?), skip frames rate (e.g., to improve efficiency and bring down processing time and resource consumption, frames can be skipped so that instead of capturing multiple frames of the same produce, more produce can be imaged and every couple of frames can be processed to determine dryness for a batch or population of the produce), and/or regions of interest in the image data.

To determine the metric of interest 316, the computer system can min-max scale (e.g., linearly, non-linearly, etc.) the image data to be within some predetermined temperature range (e.g., if the image data is gray scale). The produce can then be extracted from the image data using the bounding box information from the object detection 300. For each extracted produce, the computer system can sample pixels and generate a metric score based on temperature values of the sampled pixels. The computer system can therefore determine the dryness metric per produce, as described throughout this disclosure. Optionally, the computer system can also aggregate the metric scores of all the produce in the image data to generate a single metric score of interest for the entire batch of produce represented in the image data and/or one or more different regions of produce in the image data.

The metric of interest score can be a numeric value indicating a dryness of the produce. In some implementations, the greater the numeric value for the metric of interest score, the wetter the produce is (e.g., less dry). In some implementations, the greater the numeric value for the metric of interest score, the dryer the produce is (e.g., less wet).

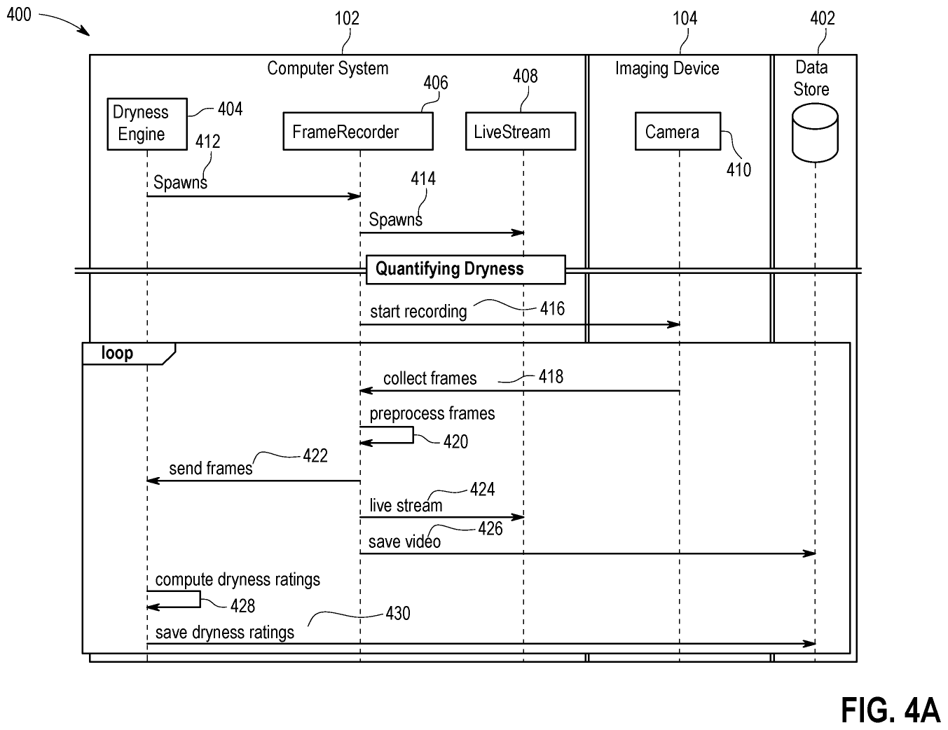

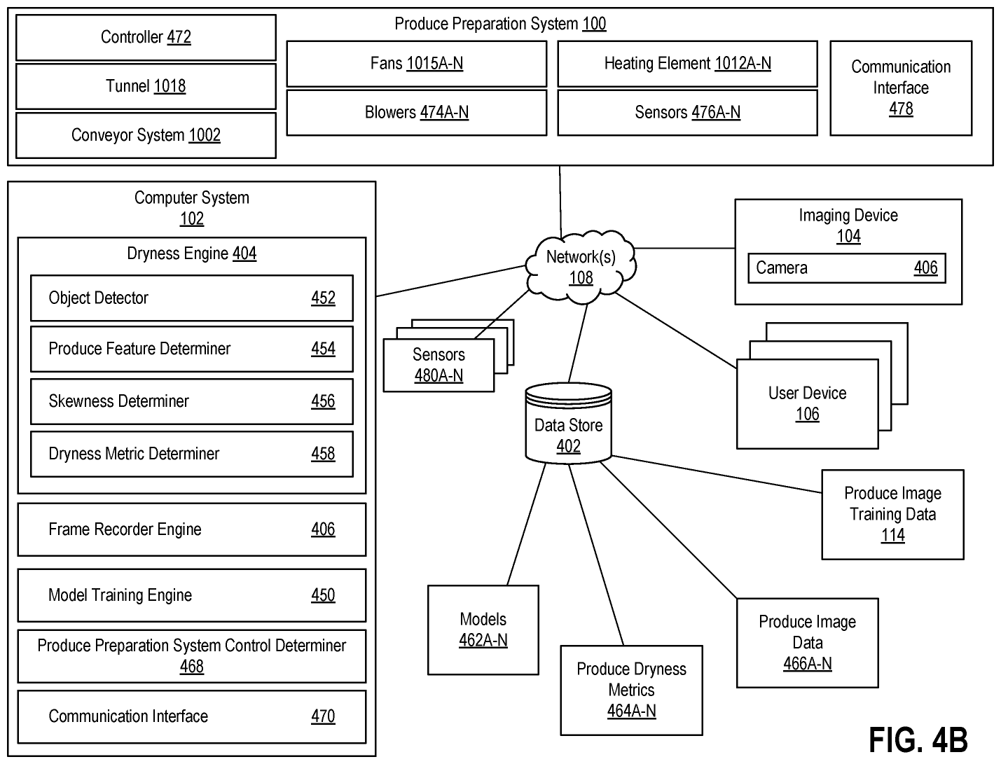

FIG. 4A is a swimlane diagram of a process 400 for determining a dryness metric for imaged produce. The process 400 can be performed by the computer system 102 and imaging device 104. The computer system 102 can include one or more components configured to perform the process 400. For example, the computer system 102 can include a dryness engine 404, a frame recorder engine 406, and a live stream engine 408. The imaging device 104 can include a camera 410. As described herein, the camera 410 can be a thermal imaging device.

Referring to the process 400, the dryness engine 404 can start a recording pipeline 416 by spawning 412 a live stream process. Similarly, the frame recorder engine 406 can spawn 414 the live stream process so that frame capturing/collection 418 by the camera 410 of the imaging device 104 is not blocked by other pipelines or processes in the process 400.

While recording 416, the camera 410 can collect frames (e.g., image data) 418. The frames can be received by the frame recorder engine 406, which can preprocess the frames 420. Preprocessing the frames 420 can include saving raw temperature frames in the data store 402, saving videos 426 (e.g., gray scale) of the produce in the data store 402, live streaming the frames 424, and sending the collected frames 422 in batches to the dryness engine 404.

Using the collected frames, the dryness engine 404 can compute dryness ratings for the produce in the frames 428. The dryness ratings can be the same as a dryness metric described throughout this disclosure. Refer to FIG. 6 for additional discussion about how the dryness ratings, or the dryness metric, can be determined by the dryness engine 404. The dryness engine 404 can also save the dryness ratings 430 in the data store 402.

Blocks 418, 420, 422, 424, 426, 428, and 430 can be performed in a loop. These blocks can continue to loop until the camera 410 is done capturing frames (e.g., image data) of the produce.

FIG. 4B is a system diagram of components that can be used to perform the disclosed techniques. As described herein, the produce preparation system 100, computer system 102, imaging device 104, user device(s) 106, and data store 402 can communicate (e.g., wired and/or wirelessly) via the network(s) 108.

In brief, the imaging device 104 can include the camera 406. The camera 406, as described herein, can be a thermal imaging camera. In some implementations, the camera 406 can be a fluorescent imaging camera. The camera 406 can capture image data (e.g., images and/or video frames) of produce as it is moved/conveyed around a processing or storage facility, as described in reference to FIG. 1A. In some implementations, the imaging device 104 may also include an optional light source, which can be used to illuminate the produce as it passes near and/or under the imaging device 104. The light source can provide even lighting across the produce so that the produce can be adequately and clearly captured in image data by the camera 406.

The computer system 102 can include the dryness engine 404, the frame recorder engine 406, a model training engine 450, a produce preparation system control determiner 468, and a communication interface 470. As described in reference to FIG. 4A, the frame recorder engine 406 can be configured to collect and process image data that is received from the imaging device 104. The frame recorder engine 406 can save the produce image data as produce image data 466A-N in the data store. The frame recorder engine 406 can also transmit the image data to the dryness engine 404 for further processing and analysis.

The model training engine 450 can be configured to train one or more models using machine learning techniques. The model training engine 450 can train the models using the produce image training data 114 stored in the data store 402. The model training engine 450 can train the models to identify dry and wet features of imaged produce, as described in reference to FIG. 1B and as used in the process 250 in FIG. 2C. The model training engine 450 can also train models to determine temperature distribution characteristics, such as skewness, and predict a dryness metric based on those characteristics. The models generated by the model training engine 450 can be stored as models 462A-N in the data store 402. In some implementations, the model training engine 450 can be part of a separate/remote computing system and/or cloud-based computing service.

The dryness engine 404, as described herein, can be configured to determine a dryness metric of produce that is imaged by the imaging device 104. The dryness engine 404 can include an object detector 452, a produce feature determiner 454, a skewness determiner 456, and a dryness metric determiner 458.

The object detector 452 can be configured to detect and identify produce in the image data that is received from the imaging device 104 (or transmitted to the dryness engine 404 by the frame recorder engine 406). The object detector 452 can use any of the object detection techniques described throughout this disclosure. Moreover, the object detector 452 can implement one or more models that were trained with machine learning techniques to identify and detect different types of produce in the image data. The object detector 452 can further extract temperature values for each produce in the image data.

The produce feature determiner 454 can retrieve one or more models 462A-N from the data store 402 and apply the retrieved model(s) to the image data that was processed by the object detector 452. By applying the model(s) to the image data, the produce feature determiner 454 can identify dry and wet features in the produce in the image data using the techniques described throughout this disclosure.

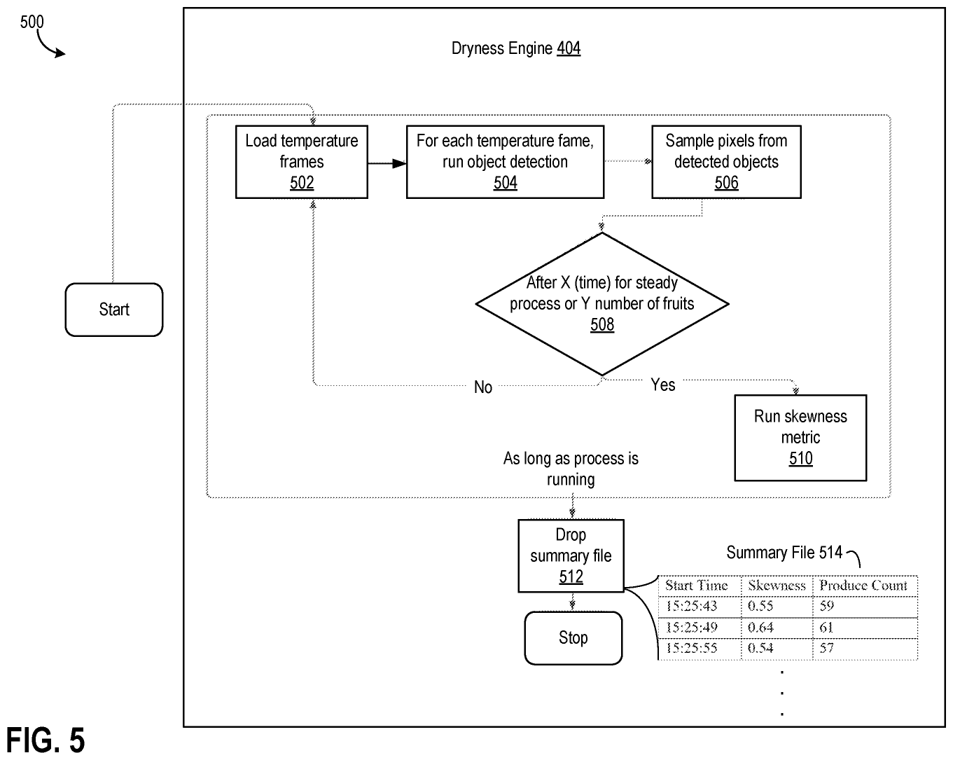

The skewness determiner 456 can receive the extracted temperature values from the object detector 452 and compute a histogram based on the extracted temperature values. The skewness determiner 456 can determine a skew of the temperature values in the histogram, thereby determining a skewness metric for the produce in the image data. Refer to FIGS. 5-7 for additional discussion about determining the skewness metric.

The dryness metric determiner 458 can receive the skewness metric from the skewness determiner 456 and predict a dryness metric for the produce based on the skewness metric. Refer to FIGS. 6-7 for additional discussion about determining the dryness metric. For example, the dryness metric determiner 458 can also determine the dryness based on the identified dry and wet features for the produce from the produce feature determiner 454.

The dryness metric can then be saved as produce dryness metrics 464A-N in the data store 402. As described herein, the dryness metric can be transmitted from the computer system 102 to one or more other systems and/or devices, such as the user device(s) 106 and/or a produce preparation system (e.g., refer to the produce preparation system 100 in FIG. 1A). The dryness metric can then be used to make adjustments to produce preparation processes and/or downstream supply chain operations, as described in reference to FIG. 1A.

The produce preparation system control determiner 468 can be configured to determine one or more adjustments to make to components of the produce preparation system 100, based at least one the produce dryness metrics 464A-N. The adjustments can be determined to achieve improved dryness of produce that go through the produce preparation system 100 as described throughout this disclosure. The adjustments can also be determined to improve energy efficiency of the produce preparation system 100 and an overall facility having the system 100. The determiner 468 can receive skewness metrics from the skewness determiner 456 and/or the dryness metrics 464A-N from the dryness metric determiner 458. The determiner 468 may also receive one or more signals determined by sensors 480A-N as produce enters and exits the produce preparation system 100. The signals can include temperature values of the produce before entering the system 100 and temperature values of the produce after exiting the system 100. Using the received metric(s) and/or sensor signals, the determiner 468 can determine whether produce are being efficiently dried to achieve a desired dryness value/condition according to current settings of the produce preparation system 100. If the determiner 468 determines that the produce are not being efficiently dried to achieve the desired dryness, based on applying criteria and/or rules to the received metric(s), the determiner 468 can generate one or more adjustments to be made to components of the produce preparation system 100. The adjustments can be determined in real-time, such as when produce is going through the system 100 to be dried, and made in real-time and/or near real-time to affect a drying process for a next batch of produce to go through the system 100. As a result, real-time, in-line adjustments can be made to the produce preparation system 100 to achieve (i) improved dryness of subsequent batches of produce and (ii) energy efficiency in the facility. Refer to FIG. 9 for further discussion about adjusting and controlling the produce preparation system 100.

The communication interface 470 can be configured to provide for communication, via the network(s) 108, between the computer system 102 and the other components described herein.

The produce preparation system 100 can be configured to prepare and dry produce in the facility, as described with regard to FIGS. 1, 10A, and 10B. The produce preparation system 100 can include a controller 472, tunnel 1018, conveyor system 1002, fans 1015A-N, blocks 474A-N, heating element 1012A-N, sensors 476A-N, and communication interface 478. In brief, the controller 472 can be configured to receive instructions for executing one or more adjustments that are determined by the produce preparation system control determiner 468. The controller 472 can execute the instructions in order to control one or more of the components 1018, 1002, 1015A-N, 474A-N, 1012A-N, and/or 476A-N. In some implementations, the controller 472 can include the produce preparation system control determiner 468. In some implementations, the controller 472 can be part of the computer system 102 and in communication via the network(s) 108 with the components 1018, 1002, 1015A-N, 474A-N, 1012A-N, and/or 476A-N. The tunnel 1018 can be a dryer and/or heat tunnel, as described throughout this disclosure. The conveyor system 1002 can be configured to move produce into and out of the tunnel 1018 of the produce preparation system 100, as described herein. Operation of the conveyor system 1002 can be adjusted, such as in speed, by the controller 472 to affect a dryness and preparation of the produce while inside the tunnel 1018. Operation of the fans 1015A-N, blowers 474A-N, and/or heating element 1012A-N can be controlled to affect one or more of airflow (flow and/or distribution), temperature (increase or decrease), and/or convection (changing airflow and/or heat direction, more or less convection in certain parts of the tunnel 1018 to affect distribution of dryness, etc.) inside the tunnel 1018 of the produce preparation system 100 as the produce is dried and prepared inside the tunnel 1018.

Moreover, the sensors 476A-N can be configured to detect various conditions inside and/or around the tunnel 1018, such as temperature, humidity, conveyor speed, etc. In some implementations, the sensors 476A-N can be the same as the sensors 480A-N. In some implementations, the sensors 476A-N and/or the sensors 480A-N can include the imaging device 104 of FIG. 1A or any other types of imaging sensors that may be used to perform the disclosed techniques. The communication interface 478 can be configured to provide communication, via the network(s) 108 between the components of the produce preparation system 100 and one or more other components described herein. Refer to FIGS. 10A-B for further discussion about the components of the produce preparation system 100

FIG. 5 is a flowchart of a process 500 for determining skewness of temperature values for imaged produce. The process 500 is similar to the pipeline 300 in FIG. 3. The process 500 can be performed by the dryness engine 404 of the computer system 102. The process 500 can also be performed by one or more other engines, computing systems, devices, computers, networks, cloud-based systems, and/or cloud-based services. For illustrative purposes, the process 500 is described from the perspective of the dryness engine 404.

Referring to the process 500, the dryness engine 404 can receive and load each temperature frame in block 502. In other words, the dryness engine 404 can receive image data of produce from an imaging device, as described in FIG. 1A. The image data can be thermal image data and thus each pixel in the image data can represent a temperature value of the imaged produce. Hence, temperature frames can be synonymous with thermal image data.

For each temperature frame, the dryness engine 404 can run object detection techniques to detect produce within the frame (block 504). The dryness engine 404 can then sample pixels from each produce that was detected using the object detection techniques (block 506).

In block 508, the dryness engine 404 can determine whether (i) a predetermined amount of time has passed that would indicate a sufficient quantity of produce was imaged or (ii) a predetermined quantity of produce were imaged in the temperature frames. If neither (i) nor (ii) are satisfied, the dryness engine 404 can return to load temperature frames in block 502. The dryness engine 404 can then repeat blocks 502-506 until either (i) or (ii) is satisfied in block 508.

If either (i) or (ii) is satisfied in block 508, the dryness engine 404 can run a skewness metric in block 510. In other words, the dryness engine 404 can determine the skewness metric for the produce in the temperature frames using one or more machine learning models.

While the process 500 is being performed (e.g., until no more produce is imaged), the dryness engine 404 can output a summary file 514 in block 512. The summary file 514 can include a table or other graphical/visual element that can indicate a start time for a particular temperature frame that was loaded in block 502, a determined skewness for that temperature frame, and a produce count for that temperature frame. The summary file 514 can be outputted at a user device, such as the user device 106 described throughout this disclosure.

FIG. 6 is a flowchart of a process 600 for determining skewness and correlating the skewness to a dryness metric for a batch of produce. The process 600 is similar to the process 200 in FIGS. 2A-B. The process 600 can be performed by the computer system 102, such as by the dryness engine 404. The process 600 can also be performed by one or more other engines, computing systems, devices, computers, networks, cloud-based systems, and/or cloud-based services. For illustrative purposes, the process 600 is described from the perspective of a computer system.

Referring to the process 600, the computer system can receive image data of a batch of produce in block 602, as described throughout this disclosure. The produce can appear within one or more frames (e.g., image data).

In block 604, the computer system can perform object detection techniques to identify bounding boxes of produce in the frame. The computer system can also identify the bounding box for each produce using a CNN or other machine learning trained model. For example, a deep learning object detector can be trained to identify or otherwise locate all produce that appear in the image data. A bounding box can be generated for each of the identified produce such that feature analysis can be performed on each of the identified produce with respect to their bounding boxes. The computer system can determine a grid structure based on the bounding boxes to index and identify each of the produce in the frame.

The computer system can then extract the bounding boxes from the image data in block 606. In block 608, the computer system can sample pixels from each extracted bounding box. As described herein, the sampled pixels can represent temperature values of portions of the produce, such as dry and wet portions of the produce.

The computer system can determine aggregate pixel value(s) for the produce in the frame in block 610. For example, the computer system can average the sampled pixels from block 608. In some implementations, the computer system can sample all pixels from each extracted bounding box in block 608 and average or otherwise aggregate all the sampled pixels to determine the aggregate pixel value for the produce in the frame in block 610.

Next, the computer system can determine skewness (e.g., a skewness metric) for the produce in the frame based on the aggregated pixel value(s) in block 612. Skewness can be determined using one or more formulas. As described herein, one or more machine learning trained models can be trained to determine the skewness. The models can, for example, implement one or more formulas to determine the skewness.

As an illustrative example, skewness can be determined using one or more standardized formulas, such as the following:

$${\overline{μ}}_{3} = \frac{{\sum }_{i}^{N} {( {X}_{i} - \overline{X} )}^{3}}{( N - 1 ) * {σ}^{3}}$$

In this exemplary formula, μ can represent an estimated skewness.

Once the skewness is determined, the computer system can determine a dryness metric based on the skewness in block 614. Since skewness is empirically correlated with dryness, the skewness metric can be rescaled to cover the dryness metric. For example, a mapping can be identified between the skewness metric and the dryness metric using a trained linear regression model. Equation 712 in FIG. 7B is an example of such mapping using linear regression. In some implementations, one or more additional features can be used with the skewness metric to predict the dryness metric using a machine learning trained model. In some implementations, the computer system can apply a machine learning trained model to the skewness to predict the dryness metric. The model can output the predicted dryness metric. Refer to FIGS. 7A1-C for additional discussion about predicting the dryness metric based on skewness.

FIGS. 7A1-B depict graphs exemplifying correlations between skewness and a dryness metric. Referring to FIG. 7A1, graph 706 depicts the skewness metric on the y axis as it correlates to the dryness metric on the x axis for various types of produce that have been imaged using the disclosed techniques. Linear regression can be used to correlate skewness to dryness in the graph 706. Refer to equation 712 in FIG. 7B for determining a curve fit (e.g., linear fit, quadratic fit, one or more other types of fits) for the plotted points in the graph 706. Linear and/or non-linear techniques can be used. As shown in the graph 706, regardless of the type of produce and/or environmental/ambient conditions where the produce are imaged, a similar trend can be seen between skewness and dryness. Dryness can be measured on a scale of 0 to 3. One or more other scales may also be used. A more positive skew can indicate that the produce is wetter and a more negative skew can indicate that the produce is dryer. The graph 706 demonstrates that as the skewness metric increases, so does the dryness metric.

Graph 708 depicts three types of curves: a positive skew 708A, a symmetrical distribution 708B, and a negative skew 708C. The negative skew 708C can indicate that a tail of the curve is on the left side of the distribution of data points while the positive skew 708A can indicate that the tail of the curve is on the right side of the distribution of data points. In some implementations, a zero value means that tails on both sides of the mean balance out, which is the symmetrical distribution 708B shown in the graph 708. As described throughout this disclosure, a more positive skew 708A can be correlated to a higher dryness metric, which indicates that the produce is more wet than dry. A more negative skew 708C can be correlated to a lower dryness metric, which indicates that the produce is more dry than wet. Finally, in some implementations, the symmetrical distribution 708B can be correlated to a neutral dryness metric, which can indicate that that the produce is neither completely wet nor completely dry but a mix of both wet and dry.

Graph 710 depicts a number of produce samples on the y axis and temperatures on the x axis for produce from two locations—location A and location B. The locations A and B can have different ambient environmental conditions that can affect temperature readings of produce that is imaged in both locations. As an illustrative example, location A can be a cold climate while location B can be a hot climate. Although these ambient environmental conditions are different, both lines for the locations A and B skew in a same direction. The temperature distribution characteristics for the lines can be correlated along a dryness metric scale to determine an accurate dryness metric for produce at each of the locations A and B.

The relative skewness amongst data points for each of the lines is relevant and thus demonstrates that each of the lines for locations A and B have a same negative skew. This same negative skew, when mapped to the dryness metric scale, can result in a same dryness metric being determined for produce at both locations A and B. In other words, the lines for locations A and B both have a negative skew towards a right side of the distribution of data points per location. The produce at both locations A and B can be assigned a same dryness metric since the lines skew by a same amount to the right side.

FIG. 7B includes an example equation 712 for determining a linear fit through the points plotted in the graph 706 in FIG. 7A1. The equation 712 can be:

Calibrated_Skewness=1.83*Skewness+1.36

A linear regression model can be used to predict a dryness metric based on the skewness, as shown with the equation 712. The values 1.83 and 1.36 in the equation 712 can be used to calibrate the skewness value for the produce to a dryness metric on a scale of 0 to 3. The same values can be used for predicting the dryness metric regardless of factors such as type of produce, processing or storage facility, ambient conditions, etc. The values can also be recalculated and/or adjusted based on new training data with observed ground truth dryness ratings under same/similar conditions and/or different conditions (where the conditions can include a type of produce, a processing or storage facility, ambient conditions, etc.).

In some implementations, the values 1.83 and 1.36 can vary depending on one or more factors, including but not limited to a scale used for the dryness metric, a type of produce, settings in a particular processing or storage facility of the produce, calibration of cameras, dryers, and other technology used for the produce, and/or environmental/ambient conditions/settings relevant to the produce.

FIG. 7C depicts a histogram 720 of temperature values for determining a dryness metric for produce based on skew of the temperature values. As described herein, a computer system can perform object detection techniques to identify produce in a frame. The computer system can then extract temperature values from pixels representing the identified produce. The computer system can plot the temperature values in the histogram 720 and determine a skewness of the plotted temperature values. This skewness can then be correlated to a dryness metric for the produce in the frame, as described throughout this disclosure.

In the histogram 720, the x axis represents temperature values that are identified from pixels of produce in the frame. The y axis represents a frequency that the temperature values are identified from the pixels of the produce in the frame. The longer the produce remains in the dryer, as shown by line 722, the histogram 720 weight shifts towards higher temperature values. The more time the produce remains in the dryer, as shown by line 724, the more distributed frequency of higher temperature values. The histogram 720 empirically correlates distribution characteristics and shapes of temperature values for produce with dryness of the produce. Skewness can therefore be calculated from the distribution characteristics and shapes shown in the histogram 720 to accurately determine a dryness metric for the produce based only on temperature values of the produce.

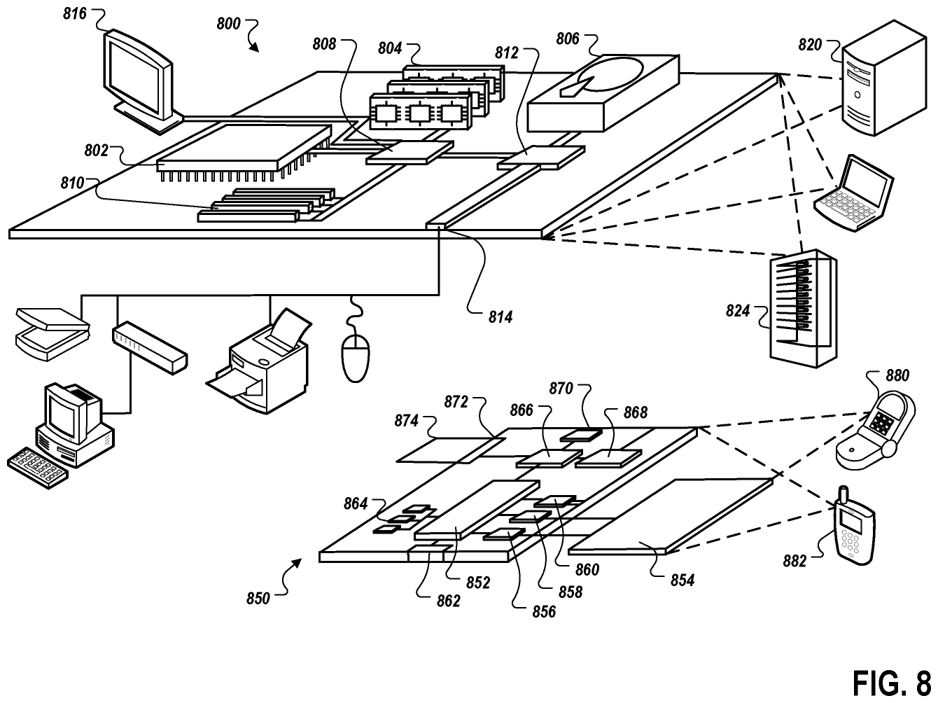

FIG. 8 shows an example of a computing device 800 and an example of a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and can be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 can also be another form of computer-readable medium, such as a magnetic or optical disk.

The storage device 806 is capable of providing mass storage for the computing device 800. In some implementations, the storage device 806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which can accept various expansion cards (not shown). In the implementation, the low-speed interface 812 is coupled to the storage device 806 and the low-speed expansion port 814. The low-speed expansion port 814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 820, or multiple times in a group of such servers. In addition, it can be implemented in a personal computer such as a laptop computer 822. It can also be implemented as part of a rack server system 824. Alternatively, components from the computing device 800 can be combined with other components in a mobile device (not shown), such as a mobile computing device 850. Each of such devices can contain one or more of the computing device 800 and the mobile computing device 850, and an entire system can be made up of multiple computing devices communicating with each other.

The mobile computing device 850 includes a processor 852, a memory 864, an input/output device such as a display 854, a communication interface 866, and a transceiver 868, among other components. The mobile computing device 850 can also be provided with a storage device, such as a micro-drive or other device, to provide additional storage. Each of the processor 852, the memory 864, the display 854, the communication interface 866, and the transceiver 868, are interconnected using various buses, and several of the components can be mounted on a common motherboard or in other manners as appropriate.

The processor 852 can execute instructions within the mobile computing device 850, including instructions stored in the memory 864. The processor 852 can be implemented as a chipset of chips that include separate and multiple analog and digital processors. The processor 852 can provide, for example, for coordination of the other components of the mobile computing device 850, such as control of user interfaces, applications run by the mobile computing device 850, and wireless communication by the mobile computing device 850.

The processor 852 can communicate with a user through a control interface 858 and a display interface 856 coupled to the display 854. The display 854 can be, for example, a TFT (Thin-Film-Transistor Liquid Crystal Display) display or an OLED (Organic Light Emitting Diode) display, or other appropriate display technology. The display interface 856 can comprise appropriate circuitry for driving the display 854 to present graphical and other information to a user. The control interface 858 can receive commands from a user and convert them for submission to the processor 852. In addition, an external interface 862 can provide communication with the processor 852, so as to enable near area communication of the mobile computing device 850 with other devices. The external interface 862 can provide, for example, for wired communication in some implementations, or for wireless communication in other implementations, and multiple interfaces can also be used.

The memory 864 stores information within the mobile computing device 850. The memory 864 can be implemented as one or more of a computer-readable medium or media, a volatile memory unit or units, or a non-volatile memory unit or units. An expansion memory 874 can also be provided and connected to the mobile computing device 850 through an expansion interface 872, which can include, for example, a SIMM (Single In Line Memory Module) card interface. The expansion memory 874 can provide extra storage space for the mobile computing device 850, or can also store applications or other information for the mobile computing device 850. Specifically, the expansion memory 874 can include instructions to carry out or supplement the processes described above, and can include secure information also. Thus, for example, the expansion memory 874 can be provide as a security module for the mobile computing device 850, and can be programmed with instructions that permit secure use of the mobile computing device 850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 864, the expansion memory 874, or memory on the processor 852. In some implementations, the computer program product can be received in a propagated signal, for example, over the transceiver 868 or the external interface 862.

The mobile computing device 850 can communicate wirelessly through the communication interface 866, which can include digital signal processing circuitry where necessary. The communication interface 866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 868 using a radio-frequency. In addition, short-range communication can occur, such as using a Bluetooth, WiFi, or other such transceiver (not shown). In addition, a GPS (Global Positioning System) receiver module 870 can provide additional navigation- and location-related wireless data to the mobile computing device 850, which can be used as appropriate by applications running on the mobile computing device 850.

The mobile computing device 850 can also communicate audibly using an audio codec 860, which can receive spoken information from a user and convert it to usable digital information. The audio codec 860 can likewise generate audible sound for a user, such as through a speaker, e.g., in a handset of the mobile computing device 850. Such sound can include sound from voice telephone calls, can include recorded sound (e.g., voice messages, music files, etc.) and can also include sound generated by applications operating on the mobile computing device 850.

The mobile computing device 850 can be implemented in a number of different forms, as shown in the figure. For example, it can be implemented as a cellular telephone 880. It can also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

FIG. 9 is a flowchart of a process 900 for adjusting a produce preparation system, such as the produce preparation system 100 described in reference to FIGS. 1A and 4B. The process 900 allows for real-time feedback to be used to dynamically control and operate components of the produce preparation system, such as a dryer or heat tunnel. The process 900 can therefore leverage information determined about produce, such as skewness and dryness metric as described throughout this disclosure, to adjust the produce preparation system in real-time and improve dryness and preparation outcomes of other produce. For example, skewness and dryness metrics can be leveraged to automatically raise or lower temperature (global and distribution temperature), increase or decrease amount of airflow, and/or adjust distribution of airflow inside the dryer or heat tunnel of the produce preparation system to optimize the produce preparation system. Real-time, in-line optimization of the produce preparation system can reduce overall energy costs of the system, reduce a CO₂ footprint of a facility utilizing the produce preparation system, and improve dryness, preparedness, and overall turnout (e.g., quality, coating) of the produce that enters the produce preparation system. Real-time, in-line adjustments of the system can also result in greater consistency of heat and/or coating solution to batches of produce.

The process 900 can be performed by the computer system 102. The process 900 can also be performed by any other computing system, computing device, and/or controller described throughout this disclosure. For illustrative purposes, the process 900 is described from the perspective of a computer system.

Referring to the process 900 in FIG. 9, the computer system can receive real-time data for produce entering and exiting a heat tunnel (e.g., the tunnel 1018 described in FIGS. 10A-B) or any other tunnel (e.g., dryer) that is part of the produce preparation system 100 described herein (block 901). The real-time data can include the image data described throughout this disclosure. The real-time data can also include temperature data about the produce before the produce enters the tunnel and after the produce exits the tunnel. The data can be received in real-time, such as when the data is determined and/or detected by sensors and/or imaging devices described herein. The data can also be received at one or more other times, in batches, and/or at predetermined time intervals.

The computer system can determine a skewness metric for the produce based on the real-time data in block 902. Refer to FIGS. 2, 6, and 7 for further discussion about determining the skewness metric. As described above, the skewness metric can be used to determine dryness efficacy of the tunnel and to identify a balance between effectively drying the produce and efficiently consuming energy.

In block 904, the computer system can determine whether the skewness metric satisfies one or more positive-skew criteria for tunnel control adjustment. The criteria can include threshold skewness values and/or ranges that apply to different types of produce. In some implementations, the criteria can include threshold skewness values and/or ranges that are specific to a type of the produce in the process 900. The computer system can compare the skewness metric to the threshold skewness value and/or range to determine whether a positive skew is represented. The computer system can also determine whether the skewness metric represents a positive skew, as described in FIGS. 2, 6, and 7.

In some implementations, the computer system can receive a dryness metric that was determined for the produce using the disclosed techniques (refer to FIGS. 2-6). The computer system can then determine whether the dryness metric satisfies criteria for tunnel control adjustment. For example, if the dryness metric is a value indicating that the produce is wet (or not dry enough) when exiting the tunnel, then the computer system can determine that the tunnel is inefficiently drying the produce at current component settings and that adjustments should be made to components of the tunnel to improve the dryness metric for subsequent produce entering the tunnel (e.g., increase temperature, convection, and/or residence time). As another example, if the dryness metric is a value indicating that the produce is burned (or too dry) when exiting the tunnel, the computer system can determine that the tunnel is inefficiently consuming energy and that adjustments should be made to the components of the tunnel to improve the dryness metric and energy consumption (e.g., decrease temperature, convection, and/or residence time).

If the one or more positive-skew criteria are not satisfied in block 904, the computer system can return to block 901 and repeat blocks 901-904. Thus, in some implementations, the heat tunnel can remain operating under its current settings rather than constantly or continually adjusting the settings. If, on the other hand, the one or more positive-skew criteria are satisfied in block 904, then the computer system can proceed to either blocks 906 or 918.

The computer system proceeds to block 906 if the skewness metric indicates a positive skew. Accordingly, the computer system identifies that the skewness metric corresponds to a positive skew (block 906). The positive skew indicates inefficient drying of the produce and that the produce is exiting the tunnel too wet. The wet produce can be as a result of temperature inside the tunnel being too low (e.g., below a threshold temperature value for drying the produce), convection inside the tunnel being too low (e.g., below a threshold airflow for drying the produce), and/or residence time inside the tunnel being too short (e.g., below a threshold amount of time for drying the produce).

The computer system determines at least one adjustment to the heat tunnel based on the positive skew identification in block 908. For example, the computer system can determine an adjustment to increase temperature inside the tunnel by a threshold amount (block 910). Additionally or alternatively, the computer system determines an adjustment to increase convection inside the tunnel by a threshold amount (block 912). Additionally or alternatively, the computer system determines an adjustment to increase residence time of produce inside the tunnel by a threshold amount (block 914). Additionally or alternatively, the computer system determines an adjustment to increase speed by which produce move through the tunnel by a threshold amount (block 916). As described below, the computer system can make one or more of the adjustments in blocks 910-916 based on a variety of factors, including but not limited to, how much energy each type of adjustment would or does consume (e.g., adjusting convection via blowers in the tunnel consumes less energy than adjusting temperature via heaters in the tunnel), how wet the produce is upon exiting the tunnel, and/or what combination of component adjustments may improve dryness of produce and consume less or a least amount of energy during operation. The computer system then proceeds to block 930 described below.

Sometimes, to determine one or more of the adjustments in blocks 908-916, the computer system can identify a delta between dryness metrics of the produce before and after entering the tunnel, a delta between skewness metrics of the produce before and after entering the tunnel, and/or a delta between surface temperature of the produce (e.g., from image data and/or temperature sensor readings, as described throughout this disclosure) before and after entering the tunnel. The computer system can also apply one or more rules and/or thresholds (e.g. the threshold amounts in blocks 910-916) to the identified delta to determine how much or how little to adjust temperature, convection, residence time, and/or speed for the tunnel.

In some implementations, the computer system can apply one or more machine learning-trained models to the skewness metric (and/or the identified deltas) to determine what control adjustments should be made and/or what combination of adjustments to temperature, convection, residence time, and/or speed may work together to improve dryness of subsequent produce while efficiently consuming energy. For example, the models can be trained to assess utility meters and other utility/energy consumption data and identify relationships between the utility/energy consumption data and dryness of the produce exiting the tunnel. Based on the identified relationships, the models can determine one or more adjustments to the tunnel that would improve dryness while maintaining energy consumption below and/or within some threshold energy consumption value/range. As an illustrative example, temperature within the tunnel may be maintained within some threshold temperature range and to not exceed that threshold temperature range but to effectively dry the produce, convection may be increased until the convection reaches or exceeds some threshold convection value and/or range. Moreover, components that provide convection throughout the tunnel, such as blowers, may consume less energy during operation and/or for extended periods of time than components that provide temperature in the tunnel, such as heaters. Consequently, the computer system can determine (for example, using the models described in this paragraph) that more adjustments to convection should be made than to temperature control for the tunnel.

Referring back to block 904, if the skewness metric satisfies the one or more positive-skew criteria and the skewness metric indicates a negative skew value, then the computer system identifies that the skewness metric represents a negative skew in block 918. Accordingly, the computer system determines at least one adjustment to the heat tunnel based on the negative skew identification in block 920. The negative skew also indicates inefficient drying of the produce, but that more energy is being consumed than actually needed to dry the produce. For example, the produce may be exiting the tunnel burned or overly dry. The produce may be burned or overly dry because the temperature inside the tunnel is too high, convection is too high, residence time is too long, and/or the speed through the tunnel is too slow.

To adjust the tunnel components, the computer system can determine an adjustment to decrease temperature inside the tunnel by a threshold amount (block 922). Additionally or alternatively, the computer system determines an adjustment to decrease convection inside the tunnel by a threshold amount (block 924). Additionally or alternatively, the computer system determines an adjustment to decrease residence time of produce inside the tunnel by a threshold amount (block 926). Additionally or alternatively, the computer system determines an adjustment to decrease speed by which produce move through the tunnel by a threshold amount (block 928). The computer system then proceeds to block 930.

As described in reference to blocks 908-916, the computer system can determine any combination of adjustments to make to the components of the tunnel that can result in improving dryness of the produce while also improving energy usage. The computer system can utilize one or more rules, threshold ranges, and/or machine learning-trained models to determine the adjustments in blocks 922-928, as described above.

In block 930, the computer system can generate and execute instructions to adjust the tunnel based on the at least one adjustment that was determined in blocks 908-916 and/or 920-928. The instructions can be transmitted to a controller of the tunnel. The controller can execute the instructions to automatically cause one or more of the components of the tunnel (e.g., blower, heater, conveyor belt) to adjust according to the at least one adjustment. The adjustment(s) can therefore be made in-line and in real-time as produce is entering and exiting the tunnel. Sometimes, for example, produce may already be inside the tunnel undergoing a drying and preparation process when adjustments are automatically being made to one or more of the tunnel components. Advantageously, this provides for improving preparation of all produce entering and exiting the tunnel, not just future produce entering the tunnel, which consequently improves overall quality of the produce in the facility. In some implementations, the computer system may generate and/or execute instructions to adjust one or more of the tunnel components once a batch of produce is detected as approaching the tunnel and/or exiting the tunnel (and before another batch of produce enters the tunnel). In such scenarios, the batch approaching the tunnel can then be evenly prepared inside the tunnel, thereby improving quality and even distribution of preparation to all produce in the batch.

Although there may be some lag time in making adjustments to the tunnel (e.g., it may take a threshold amount of time for the temperature to be raised inside the tunnel to a desired temperature value), adjustment determinations are being made at a steady state equilibrium for the tunnel. As a result, adjustment determinations are being made to compensate for the lag time. For example, as temperature increases slowly inside the tunnel due to a temperature adjustment being performed, a residence time inside the tunnel can be decreased and/or a speed through the tunnel can be increased to counteract potential issues with the lag time in temperature ramp-up (and thus prevent the produce from coming out of the tunnel too wet or burnt). The computer system can apply the models described above to determine adjustments to make that would counteract lag time during implementation of other adjustments.

The computer system can return to block 901 and continue to receive real-time data for produce entering and exiting the adjusted tunnel. The computer system can continue through the process 900 to continuously adjust one or more of the tunnel components. The process 900 provides a continuous feedback loop to generate and apply real-time, in-line adjustments to the tunnel. As a result, produce already inside the tunnel and subsequent batches of produce entering the tunnel can be more efficiently prepared and dried inside the tunnel. This can improve overall quality of the produce in the facility. The real-time in-line adjustments can also improve energy consumption of the tunnel and the facility as a whole, which can reduce the CO₂ footprint of the facility.

FIGS. 10A-B are illustrative examples of the produce preparation system 100 shown and described in FIG. 1A. Referring to both FIGS. 10A-B, the produce preparation system 100 (e.g., a treatment apparatus) can include a drying apparatus, as described herein. The system 100 can also be configured to treat produce by applying a shelf-life coating solution. For example, the system 100 can facilitate application of a water-based coating solution to produce a coating layer having one or more desired characteristics on produce that enters the system 100. The system 100, and one or more of its operating components, may facilitate drying of a relatively high-water content of the coating solution while producing a coating having characteristics within predetermined ranges, such as a predetermined coating thickness, coating mosaicity, etc. In some implementations, as described above, relatively high heat may be applied to the produce to facilitate evaporation of a substantial portion of the water content of the coating solution, without damaging the produce (e.g., which may be sensitive to prolonged exposure to heat, or temperatures above a threshold value).

The system 100 can include a drying tunnel 1018 and a conveyer system 1002 configured to move the produce through the drying tunnel 1018. The drying tunnel 1018 can be any other type of heat tunnel, dryer, tunnel, or smart tunnel described throughout this disclosure. The system 100 can further be used with, or include, an infeed system, a bed, one or more coating applicators, and/or a packing station. By way of example, the infeed system can include a loading system on which produce are loaded manually or automatically. In some implementations, the produce can be sorted, for example, by size, color, and/or stage of ripening at the infeed system. Alternatively, the produce can be sorted before arriving at the infeed system. The bed can transport the produce at the system 100, such as from the infeed system to the packing station through different components of the system 100. The bed can be of various types, such as a brush bed, rolling translating conveyer, etc. The applicators can operate to apply a coating solution (e.g., treatment agent) on the produce being transported on the bed. Alternatively or in addition, the produce may be coated with the coating solution by being submerged in the coating solution. The tunnel 1018 can operate to remove moisture and dry the coating solution applied on the produce, as described throughout this disclosure. The packing station can facilitate packing the treated produce for transport (e.g., to retail stores, consumers, food production plants, or other relevant stakeholders in a supply chain.

The tunnel 1018 can include various components to facilitate drying the coating solution on the produce. In some implementations, the components may include heated air blowers 474A-N (e.g., refer to FIG. 4B) that are located over drying brushes and drying tunnels with roller conveyors. For example, the tunnel 1018 can include at least one blower 474A-N that pushes hot air into the tunnel 1018 and fans 1015A-N (refer to FIGS. 4B and 10B) along a length inside the tunnel 1018 to provide additional airflow. In another example, the tunnel 1018 may employ a pressure buildup with a perforated plate to supply high velocity air across a path by which the produce move inside the tunnel 1018. In some implementations, temperature set points for the tunnel 1018 can be between 45-95° C., 50-90° C., 55-85° C., and/or 65-80° C. The temperature set points can vary based on type of produce entering and exiting the tunnel 1018, energy consumption of components of the tunnel 1018, and/or operational settings of one or more of the components of the tunnel 1018, such as the blowers 474A-N, the fans 1015A-N, and/or the conveyor system 1002. Sometimes, direct fire burners can be used for adjusting temperature inside the tunnel 1018. Anodized aluminum rollers may additionally or alternatively be used. The tunnel 1018 may include air recirculation, and optionally humidity control systems with the addition of a ventilation duct and modulating exhaust. High-pressure blowers may be provided to supply air to a perforated plate, which can provide a high velocity of air (e.g., convection) across the produce path of movement. Air may be recirculated from both sides of the tunnel 1018, for example, to provide for even distribution of temperature and/or airflow over an entire batch of produce as it moves through the tunnel 1018.

The system 100 can utilize the conveyor system 1002 for moving the produce while the coating solution is applied to the produce and/or while the produce are being dried. In some implementations, the conveyor system 1002 includes a conveyor bed configured to cause the produce to simultaneously rotate as they move from one section to another, facilitating complete surface coverage and/or drying. Alternatively, or additionally, the system 100 can include other components such as sprayers and/or blowers that directly treat and/or facilitate drying of the produce while they are on the bed of the conveyor system 1002. For example, one or more sprayers can be mounted over the bed and used to spray liquid droplets of the coating solution on the produce as the produce passes the sprayers. The liquid droplets can, for example, include a sanitizing agent such as ethanol. The liquid droplets can alternatively include water, combinations of ethanol and water, or other solvents suitable for treatment of the produce. Alternatively, the sprayers can indirectly treat or coat the produce by saturating rollers over which the produce moves. The rollers can move independently from a belt or chain drive system that moves the conveyor 1002, rotating the produce, such that the rollers act to coat the produce with the solution thereon.

Other types of components for treating the produce on the conveyor system 1002 bed can also be provided at the system 100. For example, fans 1015A-N, blowers 474A-N, and/or air knives can be mounted with their exhaust over the bed of the conveyor system 1002 and used to blow air or other gasses (e.g., nitrogen gas or air/nitrogen mixtures) onto the produce in order to facilitate drying of the produce inside the tunnel 1018. The system 100 can include a mixing system for preparing solutions or suspensions that are sprayed onto the produce, as well as a liquid delivery system that transports the solution/suspension from the mixing system to the sprayers at a suitable pressure and flow rate.

The conveyer system 1002 can include a motor 1004 and a take-up roller 1006 configured to operate the conveyor system 1002. A roll cleaning assembly 1020 can be provided to clean a bed (and rollers) of the conveyor system 1002.

The system 100 can further include various components for circulating conditioned air for drying produce that are transported by the conveyor system 1002. For example, the system 100 can include at least one intake blower 1008 configured to draw air into the tunnel 1018, and at least one exhaust blower 1010 configured to discharge air from the tunnel 1018. The system 100 can further include at least one heating element 1012 to adjust a temperature of air circulating inside the tunnel 1018. One or more hot air recirculation control dampers 1014 can control volume of recirculated air and/or facilitate control of one or more air temperature and humidity values. The system 100 can also include one or more airflow control panels 1016 that are disposed at different locations in the tunnel 1018 and configured to control airflow at such locations. The system 100 can further include one or more fan assemblies 1015 that are disposed at different locations in the tunnel 1018 and configured to drive airflow at desired directions.

In some implementations, the system 100 can include various sensors to measure parameters that can be used to determine a drying performance in the tunnel 1018 and/or one or more adjustments to make to components of the system 100. The system 100 can include, for example, temperature sensors, air velocity sensors, heater control sensors, and/or imaging sensors. As described above in reference to FIGS. 4B and 9, any of the components of the produce preparation system 100 can be adjusted and/or controlled by the computer system 102 in order to improve effectiveness of drying the produce inside the tunnel 1018 as well as to improve energy usage of the system 100 and the facility as a whole.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for determining dryness of produce using image data, the method comprising:
receiving, by a computing system and from an imaging device, image data of a batch of produce;
performing, by the computing system, object detection to identify each produce in a frame of the image data;
extracting, by the computing system, temperature values in pixels of the identified produce in the frame;
determining, by the computing system, distribution characteristics of the extracted temperature values;
predicting, by the computing system, a dryness metric for the batch of produce based on applying a trained model to the determined distribution characteristics, wherein the model was trained using temperature distributions of other produce, the temperature distributions being annotated based on previous mappings of skewness of the temperature distributions to dryness; and
returning, by the computing system, the dryness metric for the batch of produce.

2. The method of claim 1, wherein the model is at least one of a linear regression model and a non-linear regression model.

3. The method of claim 1, wherein the distribution characteristics include skewness of the extracted temperature values.

4. The method of claim 1, wherein determining, by the computing system, distribution characteristics of the extracted temperature values comprises:
mapping the extracted temperature values into a histogram; and
analyzing a distribution of points in the histogram.

5. The method of claim 4, wherein analyzing, by the computing system, the distribution of points in the histogram comprises determining a skew of the points in the histogram.

6. The method of claim 1, further comprising extracting, by the computing system, temperature values in pixels of the identified produce in the frame until a quantity of the extracted temperature values satisfies a threshold quantity.

7. The method of claim 1, further comprising extracting, by the computing system, temperature values in pixels of the identified produce in the frame until a quantity of produce in the frame satisfies a threshold produce quantity.

8. The method of claim 1, further comprising extracting, by the computing system, temperature values in pixels of the identified produce in the frame until a time period of extracting the temperature values satisfies a threshold timeframe.

9. The method of claim 1, wherein the other produce are of a different produce type than the batch of produce in the image data.

10. The method of claim 1, wherein a higher dryness metric is correlated with a more positive skewness metric, and a lower dryness metric is correlated with a more negative skewness metric.

11. The method of claim 10, wherein the more negative skewness metric indicates that the batch of produce is drier, and the more positive skewness metric indicates that the batch of produce is wetter.

12. The method of claim 1, further comprising determining, by the computing system, at least one modification to a produce preparation process used for one or more batches of produce based on the dryness metric.

13. The method of claim 12, wherein the one or more batches of produce are of a different produce type than the batch of produce in the image data.

14. The method of claim 12, wherein the produce preparation process includes coating the one or more batches of produce in a shelf life extension coating solution.

15. The method of claim 12, wherein the produce preparation process includes moving, by an automated conveyor system, the one or more batches of produce through a drying tunnel for a predetermined amount of time to dry the one or more batches of produce.

16. The method of claim 12, wherein the produce preparation process includes moving, by an automated conveyor system, the one or more batches of produce through a heating tunnel for a predetermined amount of time at a predetermined temperature to dry the one or more batches of produce.

17. The method of claim 12, wherein the at least one modification to the produce preparation process comprises modifying, by a produce preparation system, a formula of a shelf life extension coating solution that is applied to the one or more batches of produce before the one or more batches of produce are transported to end consumers.

18. The method of claim 12, wherein the at least one modification to the produce preparation process comprises adjusting, by a produce preparation system, a temperature of a heating tunnel that is used to dry the one or more batches of produce before the one or more batches of produce are transported to end consumers.

19. The method of claim 12, wherein the at least one modification to the produce preparation process comprises adjusting, by a produce preparation system, an amount of time that the one or more batches of produce are dried in a drying tunnel before the one or more batches of produce are transported to end consumers.

20. The method of claim 12, wherein determining, by the computing system, at least one modification to a produce preparation process comprises:
receiving a skewness metric for the batch of produce, wherein the skewness metric is determined based on the distribution characteristics of the extracted temperature values for the batch of produce;
determining whether the skewness metric satisfies positive-skew criteria for adjusting one or more components of an in-line drying tunnel, wherein the batch of produce passes through the in-line drying tunnel as part of the produce preparation process before being imaged by the imaging device, wherein satisfying the positive-skew criteria indicates that the batch of produce has a threshold level of wetness upon exiting the in-line drying tunnel;
determining at least one produce-drying adjustment to at least one of the components of the in-line drying tunnel based on a determination that the skewness metric satisfies the positive-skew criteria, wherein the produce-drying adjustment includes at least one of: increasing a temperature control inside the in-line drying tunnel by a threshold temperature amount, increasing a convection control inside the in-line drying tunnel by a threshold convection amount, increasing a residence time of the one or more batches of produce inside the in-line drying tunnel by a threshold amount of time, and increasing a speed by which the one or more batches of produce are moved, by an automated conveyor system, through the in-line drying tunnel;
generating instructions to adjust the at least one of the components according to the determined at least one produce-drying adjustment; and
executing the instructions in real-time while the one or more batches of produce are passing through the in-line drying tunnel to automatically adjust the at least one of the components.

21. The method of claim 20, further comprising iteratively:
receiving a skewness metric for the one or more batches of produce;
determining whether the skewness metric satisfies the positive-skew criteria;
determining at least one produce-drying adjustment to at least one of the components of the in-line drying tunnel based on a determination that the skewness metric satisfies the positive-skew criteria;
generating instructions; and
executing the instructions in real-time.

22. The method of claim 20, further comprising:
determining at least one energy-usage adjustment to at least one of the components of the in-line drying tunnel based on a determination that the skewness metric does not satisfy the positive-skew criteria,
wherein the positive-skew criteria is not satisfied when, based on the dryness metric, the batch of produce is burnt upon exiting the in-line drying tunnel,
wherein the energy-usage adjustment includes at least one of: decreasing the temperature control inside the in-line drying tunnel by a threshold temperature amount, decreasing the convection control inside the in-line drying tunnel by a threshold convection amount, decreasing the residence time of the one or more batches of produce inside the in-line drying tunnel by a threshold amount of time, and decreasing the speed by which the one or more batches of produce are moved, by an automated conveyor system, through the in-line drying tunnel;
generating instructions to adjust the at least one of the components according to the determined at least one energy-usage adjustment; and
executing the instructions in real-time while the one or more batches of produce are passing through the in-line drying tunnel to automatically adjust the at least one of the components.

23. The method of claim 20, further comprising: determining, by the computing system, the skewness metric based on the distribution characteristics of the extracted temperature values for the batch of produce.

24. The method of claim 1, further comprising transmitting, by the computing system and to a user device, the dryness metric of the batch of produce for display at the user device.
